(19) United States
(12) Patent Application Publication
(10) Pub. No.: US 2011/0026120 A1
(43) Pub. Date: Feb. 3, 2011

(54) Antireflective film, polarizing plate, and image display device

(75) Inventors: Masaaki Suzuki, Kanagawa (JP); Hiroyuki Yoneyama, Kanagawa (JP); Katsuyuki Takada, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/805,443

(22) Filed: Jul. 30, 2010

(30) Foreign Application Priority Data
Jul. 31, 2009 (JP) P2009-180218

(51) Int. Cl. G02B 1/11

(52) U.S. Cl. 359/580

(57) ABSTRACT

An antireflective film is provided and includes: a support; and a low refractive index layer formed from a composition for low refractive index layer, the composition including the components (A) and (B):
(A) a fluorine-containing polymer having a crosslinking group, and
(B) a conductive polymer composition including a π-conjugated conductive polymer and a polymer dopant having an anion group, the conductive polymer composition being hydrophobized. The antireflective film has a Log SR of 13 or less, Log SR being a common logarithm of a surface resistivity SR (Ω/sq) of a surface on a side having the low refractive index layer with respect to the support.

This application is based on and claims priority under 35 U.S.C. §119 from Japanese Patent Application No. 2009-180218, filed Jul. 31, 2009, the entire disclosure of which is herein incorporated by reference.

### BACKGROUND OF THE INVENTION

1. Field of the Invention

The present invention relates to an antireflective film having high antistatic property and antireflection property, a polarizing plate using the antireflective film, and an image display device using the antireflective film or the polarizing plate on the outermost surface of the display.

2. Description of Related Art

In image display devices such as a cathode ray tube displays (CRT), plasma displays (PDP), electroluminescence displays (ELD), and liquid crystal display devices (LCD), antireflective films are generally provided on the outermost surface of the display for reducing reflectance by using the principle of optical interference, in order to prevent contrast reduction or reflection of an image due to the reflection of external light.

In the antireflective film, a low refractive index layer having an adequate film thickness and having a lower refractive index than that of a support is usually formed on the support directly or via a another layer. To realize a low reflectance, a low refractive index layer is required to use a material having a refractive index as low as possible. In addition, the antireflective film is required to have high scratch resistance because it is used on the outermost surface of a display. For example, in order to obtain a thin film of about 100 nm thick having high scratch resistance, adequate strength of a film itself and adhesion to the underlying layer are necessary.

As a method for reducing the refractive index of a material, there is known a method of introducing a fluorine atom therein. In particular, a fluorine-containing crosslinking material is proposed (refer to JP-A-8-92323, JP-A-2003-222702, and JP-A-2003-26732). When a fluorine-containing layer is placed on the outermost surface of the antireflective film, however, an increase in the proportion of a fluorine atom in a compound so as to reduce the refractive index of the film facilitates negative charging of the film surface and dust sticking.

It is known to provide an antireflective film with a layer (antistatic layer) having conductivity in order to reduce sticking of dust and the like and thereby leak charges from the surface of the antireflective film.

For example, JP-A-2005-196122 and JP-A-2003-294904 disclose an antireflective film equipped with an antistatic layer containing conductive particles. This method requires formation of a new layer in addition to a low refractive index layer so that it is inferior in productivity due to heavy burden of equipment or time necessary for production of the antireflective film. Further, many of antistatic conductive particles made of a metal oxide, which have been used conventionally, have a refractive index of from about 1.6 to 2.2 so that the antistatic layer containing these particles has inevitably an increased refractive index. An increase in the refractive index of the antistatic layer may cause problems in an optical film such as unexpected interference unevenness due to a difference in refractive index between the antistatic layer and a layer adjacent thereto or enhancement of reflected colors.

JP-A-2007-185824, JP-A-2005-31645, JP-A-2007-293325, and JP-A-2007-114772 propose a method of kneading a conductive filler in a low refractive index layer. In this system, there is a trade-off relationship between improvement in conductivity and antireflective performances. An increase in the kneading amount of conductive filler in the refractive index layer improves conductivity but deterioration in antireflective performances is inevitable due to an increase in the refractive index of the layer. As a result, satisfactory antireflective performances and conductivity cannot necessarily be attained and there is therefore a demand for further improvement.

JP-A-2007-185824, JP-A-2005-31645, and JP-A-2007-293325 describe modes in which a conductive material having ion conductivity or electron conductivity is added to a low refractive index layer. Only a conductive material having ion conductivity is described in Examples of these patent documents. There is a trade-off relationship between improvement in the conductivity and antireflective performances and in addition, the conductivity is not always sufficient, which depends on the environmental humidity. In addition, as examples of conductive polymers, organic conductive polymer compounds such as polyaniline and polythiophene are given. A low refractive index layer having such a compound introduced therein however does not substantially show conductivity and partial oxidation of it by doping is necessary therefor. Conventionally used conductive polymers containing an anion dopant have high hydrophilicity and low compatibility with a material such as fluorine-containing polymer so that troubles such as inferior solubility of a coating solution, cissing, uneven film thickness occur. It is therefore difficult to form a low refractive index layer excellent in surface state by using such materials.

European Patent No. 328981 discloses that a polythiophene derivative soluble in organic solvents can be synthesized by electropolymerization using, in an organic solvent system, a thiophene derivative and a monomer dopant soluble in organic solvents. It has however been elucidated that although the polythiophene derivative soluble in organic solvents tends to have improved compatibility with a fluorine-containing polymer, it has the problem that when it is used for an antireflective film serving as a protective film of a polarizing plate, the monomer dopant is eluted from the film by alkali treatment (saponification), leading to a marked deterioration in conductivity.

### SUMMARY OF THE INVENTION

An object of the invention is to provide an antireflective film that has excellent antireflective performances and conductivity and good scratch resistance and antifouling property and can be produced with high productivity.

Another object of the present invention is to provide a polarizing plate and an image display device using the antireflective film as described above.

With a view to achieving the above-described objects, the present inventors have carried out an extensive investigation. As a result, it has been found that the objects can be achieved by the constitution described below, leading to the completion of the invention. In short, the invention can achieve the above-described objects with the following constitution.
1. An antireflective film comprising:

a support; and

a low refractive index layer formed from a composition for low refractive index layer, the composition including the components (A) and (B):

(A) a fluorine-containing polymer having a crosslinking group, and

(B) a conductive polymer composition including a π-conjugated conductive polymer and a polymer dopant having an anion group, the conductive polymer composition being hydrophobized,

wherein the antireflective film has a Log SR of 13 or less, Log SR being a common logarithm of a surface resistivity SR (Ω/sq) of a surface on a side having the low refractive index layer with respect to the support.
2. The antireflective film according to item 1, wherein the π-conjugated conductive polymer is one selected from the group consisting of polythiophene, polyaniline, polythiophene derivatives, and polyaniline derivatives.
3. The antireflective film according to item 1 or 2, wherein the fluorine-containing polymer (A) is a copolymer represented by formula (1):

(MF1)ₐ-(MF2)_{b}-(MF3)_{c}-(MA)_{d}-(MB)ₑ

wherein a to e represent molar fractions of respective constituents and satisfy: 0≦a≦70, 0≦b≦70, 30≦a+b≦70, 0≦c≦50, 5≦d≦50, and 0≦e≦50,

(MF1) represents a constituent obtained by polymerizing a monomer represented by CF₂═CF—Rf₁ in which Rf₁ represents a perfluoroalkyl group having 1 to 5 carbon atims,

(MF2) represents a constituent obtained by polymerizing a monomer represented by CF₂═CF—ORf₁₂ in which Rf₁₂ represents a fluorine-containing C₁₋₃₀ alkyl group,

(MF3) represents a constituent obtained by polymerizing a monomer represented by CH₂═CH—ORf₁₃ in which Rf₁₃ represents a fluorine-containing alkyl group having 1 to 30 carbon atoms,

(MA) represents a constituent having at least one crosslinking moiety, and

(MB) represents an optional constituent.
4. The antireflective film according to item 3, wherein (MB) includes a constituent having a polysiloxane structure.
5. The antireflective film according to any one of items 1 to 4, wherein the composition for low refractive index layer further comprises (C) a monomer having two or more (meth)acryloyl groups in a molecule thereof.
6. The antireflective film according to any one of items 1 to 5, wherein the composition comprises (D) inorganic fine particles having an average particle size of from 1 to 200 nm.
7. The antireflective film according to item 6, wherein the inorganic fine particles (D) includes a porous inorganic fine particle or an inorganic fine particle having a cavity inside thereof.
8. The antireflective film according to any one of items 1 to 7, wherein the composition for low refractive index layer further comprises (E) a fluorine-containing antifouling agent having a functional group capable of being cured with ionizing radiation.
9. The antireflective film according to any one of items 1 to 8, wherein the conductive polymer composition is distributed unevenly in a part, closer to the support in a thickness direction, of the low refractive index layer.
10. A polarizing plate comprising a polarizer and two protective films for protecting both a surface side and back side of the polarizer, wherein one of the protective films is an antireflective film as described in any one of items 1 to 9.
11. An image display device comprising an antireflective film as described in any one of items 1 to 9 or a polarizing plate as described in item 10.

### DETAILED DESCRIPTION OF EXEMPLARY EMBODIMENTS

According to an exemplary embodiment of the invention, it is possible to provide an antireflective film that has excellent antireflective performances and conductivity and good scratch resistance and antifouling property and can be produced with high productivity.

Also, it is possible to provide a high-quality polarizing plate and image display device by using such an antireflective film.

Exemplary embodiments of the present invention will hereinafter be described more specifically. In the present specification, when the numerical values denote physical property values, characteristic values, or the like, the expression “(numerical value 1) to (numerical value 2)” means “(numerical value 1) or greater but not greater than (numerical value 2)”. Further, in the present specification, the term “(meth)acrylate” means “at least one of acrylate and methacrylate”. The same shall apply to “(meth)acrylic acid”, and the like. Further, in the present invention, “Cₖ₋₁ group” means that the number of carbon atoms in the group is from k to 1.

### [Low Refractive Index Layer]

The antireflective film of the invention has, on a support thereof, a low refractive index layer formed from a composition for low refractive index layer, the composition including the components (A) and (B):

(A) a fluorine-containing polymer having a crosslinking group, and

(B) a conductive polymer composition including a π-conjugated conductive polymer and a polymer dopant having an anion group, the conductive polymer composition being hydrophobized.

The antireflective film of the present invention has a common logarithm (Log SR) of 13 or less, Log SR being a common logarithm of a surface resistivity SR (Ω/sq) of a surface on a side having the low refractive index layer with respect to the support. Log SR is preferably 3 or greater but not greater than 13, more preferably 4 or greater but not greater than 12, still more preferably 5 or greater but not greater than 10.

By using the above-described constitution, an antireflective film excellent in dust resistance and equipped with sufficient antireflective performances can be obtained.

The above-described components (A) and (B) to be used for the low refractive index layer and the other additional constituents usable for the low refractive index layer will next be described.

### [(A) Fluorine-Containing Polymers Having a Crosslinking Group]

A low-refractive-index layer composition for forming a low refractive index layer (i.e., a composition for low refractive index layer) contains (A) a fluorine-containing polymer having a crosslinking group (which polymer may hereinafter be called “fluorine-containing polymer (A)”, simply).

The term “crosslinking group” as used herein means a functional group capable of taking part in a crosslinking reaction. Examples of the crosslinking group include silyl groups having a hydroxyl group or a hydrolyzable group (such as alkoxysilyl group and acyloxysilyl group), groups having a reactive unsaturated double bond (such as (meth)acryloyl group, allyl group, and vinyloxy group), ring-opening polymerization reactive groups (such as epoxy group, oxetanyl group, and oxazolyl group), groups having an active hydrogen atoms (such as hydroxyl group, carboxyl group, amino group, carbamoyl group, mercapto group, β-ketoester group, hydrosilyl group, and silanol group), and groups substituted with an acid anhydride or nucleophilic agent (such as active halogen atom and sulfonic acid ester).

Although no particular limitation is imposed on the fluorine-containing polymer (A) insofar as it has a fluorine-containing moiety and a moiety having a functional group capable of taking part in a crosslinking reaction and has a molecular weight of about 1000 or greater, copolymers represented by, for example, the following of formula (1) are preferred. Formula (1):

(MF1)ₐ-(MF2)_{b}-(MF3)_{c}-(MA)_{d}-(MB)ₑ

wherein, a to e represent molar fractions of the respective components and satisfy the following relationships: 0≦a≦70, 0≦b≦70, 30≦a+b≦70, 0≦c≦50, 5≦d≦50, and 0≦e≦50.

(MF 1): a constituent obtained by polymerization of a monomer represented by CF₂═CF—Rf₁ in which Rf₁ represents a C₁₋₅ perfluoroalkyl group.

(MF2): a constituent obtained by polymerization of a monomer represented by CF₂═CF—ORf₁₂ in which Rf₁₂ represents a fluorine-containing C₁₋₃₀ alkyl group.

(MF3): a constituent obtained by polymerization of a monomer represented by CH₂═CH—ORf₁₃ in which Rf₁₃ represents a fluorine-containing C₁₋₃₀ alkyl group.

(MA): a constituent having at least one crosslinking moiety.

(MB): an optional constituent.

Each monomer (compound represented by the below-described formulas (1-1) to (1-3)) in the (MF1) to (MF3) will next be described.

CF₂═CF—Rf₁ Formula (1-1)

In the formula, Rf₁ represents a C₁₋₅ perfluoroalkyl group.

The compound of the formula (1-1) is preferably perfluoropropylene or perfluorobutylene from the standpoint of polymerization reactivity, with perfluoropropylene being especially preferred from the standpoint of availability.

CF₂═CF—ORf₁₂ Formula (1-2)

In the formula, Rf₁₂ represents a fluorine-containing C₁₋₃₀ alkyl group. The fluorine-containing alkyl group may have a substituent. Rf₁₂ is preferably a fluorine-containing C₁₋₂₀ alkyl group, more preferably a fluorine-containing C₁₋₁₀ alkyl group, still more preferably a C₁₋₁₀ perfluoroalkyl group. The following ones are specific examples of Rf₁₂ but it is not limited to them.

—CF₃, —CF₂CF₃, —CF₂CF₂CF₃—, —CF₂CF(OCF₂CF₂CF₃)CF₃

CH₂═CH—ORf₁₃ Formula (1-3)

In the formula, Rf₁₃ represents a fluorine-containing C₁₋₃₀ alkyl group. The fluorine-containing alkyl group may contain a substituent. Rf₁₃ may have a linear structure or a branched structure. Alternatively, Rf₁₃ may have an alicyclic structure (preferably, a five-membered ring or a six-membered ring). Further, Rf₁₃ may have an ether linkage between two carbons. Rf₁₃ is preferably a fluorine-containing C₁₋₂₀ alkyl group, more preferably a fluorine-containing C₁₋₁₅ alkyl group.

The following are specific examples of Rf₁₃, but it is not limited to them.

### (Linear)

—CF₂CF₃, —CH₂(CF₂)ₐH, —CH₂CH₂(CF₂)ₐF (a: an integer from 2 to 12)

### (Branched Structure)

—CH(CF₃)₂, —CH₂CF(CF₃)₂, —CH(CH₃)CF₂CF₃, —CH(CH₃)(CF₂)₅CF₂H

### (Alicyclic Structure)

Perfluorocyclohexyl group or perfluorocyclopentyl group, or alkyl group substituted therewith

### (The Other Structures)

CH₂OCH₂CF₂CF₃, —CH₂CH₂OCH₂(CF₂)_{b}H, —CH₂CH₂OCH₂(CF₂)_{b}F (b: an integer from 2 to 12), —CH₂CH₂OCF₂CF₂OCF₂CF₂H

In addition, as the monomer represented by the formula (1-3), those described in, for example, the paragraphs from [0025] to [0033] of Japanese Patent Laid-Open No. 2007-298974 can be used.

The (MA) of the formula (1) represents a constituent containing at least one crosslinking moiety (a reactive moiety capable of taking part in a crosslinking reaction).

Examples of the crosslinking moiety include silyl groups having a hydroxyl group or a hydrolyzable group (such as alkoxysilyl group and acyloxysilyl group), groups having a reactive unsaturated double bond (such as (meth)acryloyl group, allyl group, and vinyloxy group), ring-opening polymerization reactive groups (such as epoxy group, oxetanyl group, and oxazolyl group), groups having an active hydrogen atom (such as hydroxyl group, carboxyl group, amino group, carbamoyl group, mercapto group, β-ketoester group, hydrosilyl group, and silanol group), acid anhydride, and groups substituted with an nucleophilic agent (such as active halogen atom and sulfonic acid ester).

The crosslinking group of (MA) is preferably a group having a reactive unsaturated double bond (such as (meth)acryloyl group, allyl group, or vinyloxy group), a ring-opening polymerization reactive group (such as epoxy group, oxetanyl group, or oxazolyl group), or a group having an active hydrogen atom (such as hydroxyl group, carboxyl group, amino group, carbamoyl group, mercapto group, β-ketoester group, hydrosilyl group, or silanol group), more preferably a group having a reactive unsaturated double bond (such as (meth)acryloyl group, allyl group, or vinyloxy group).

The following are preferred specific examples of the constituent represented by (MA) in the formula (1), but the invention is not limited to them.

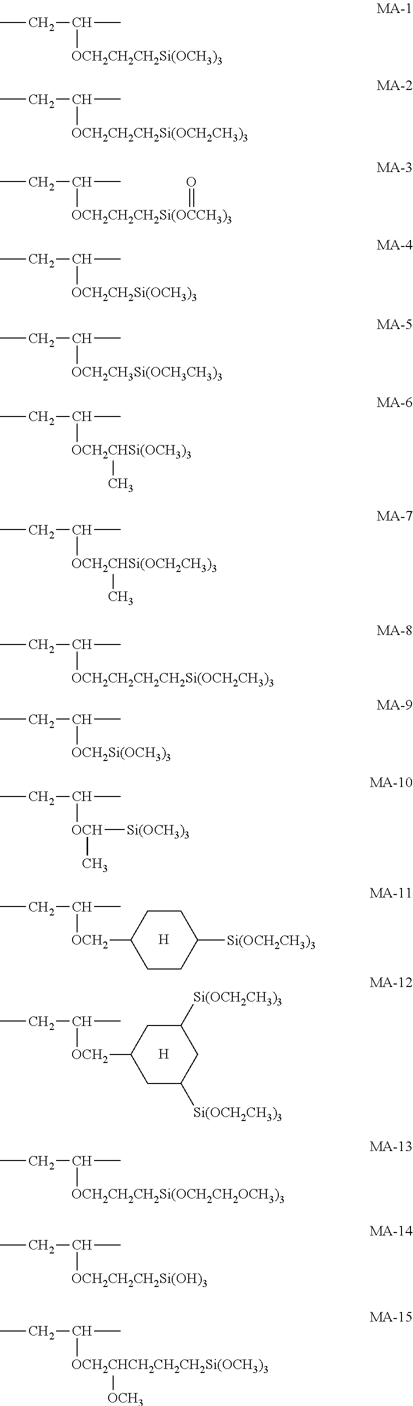

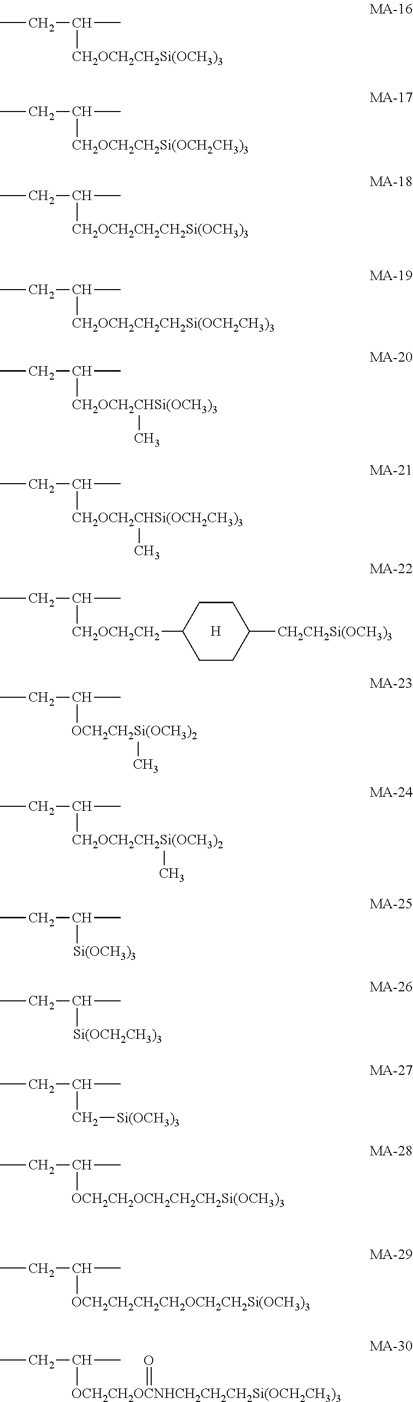

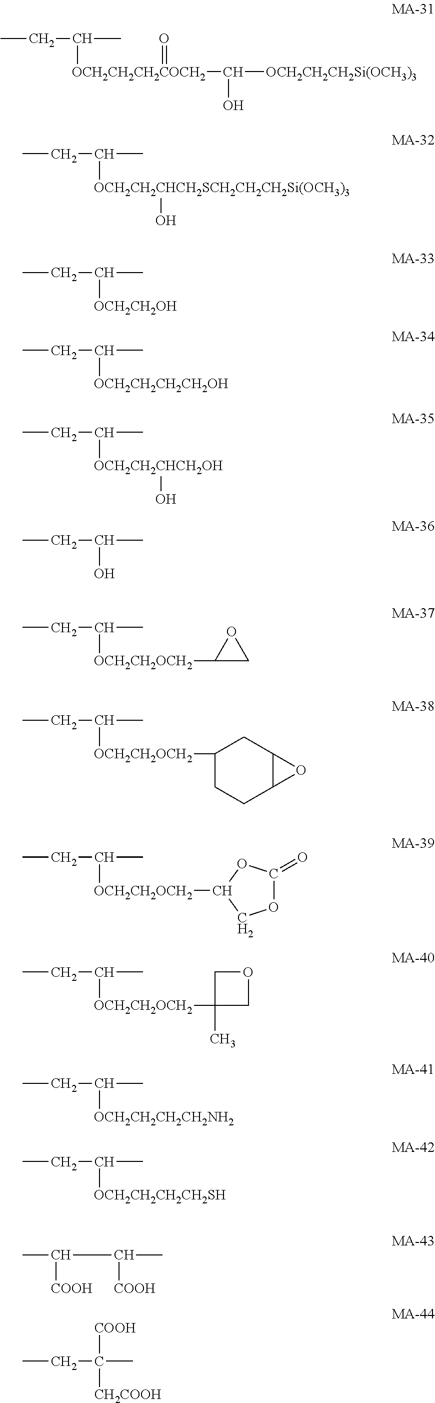

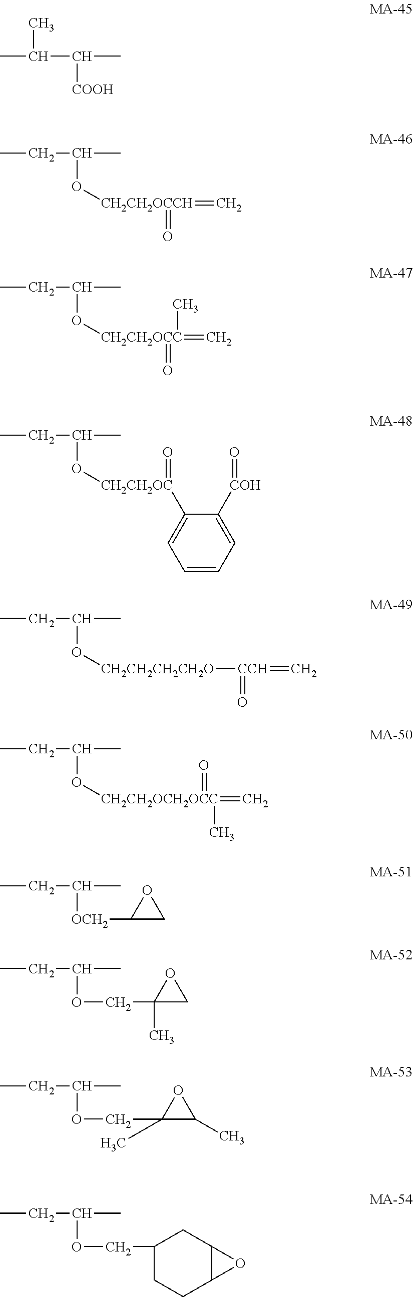

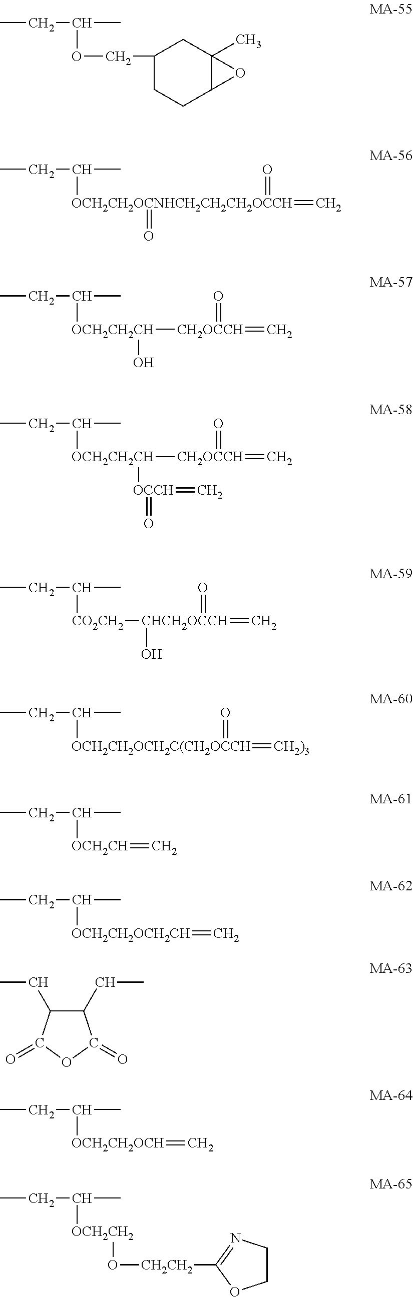

(MB) in the formula (1) represents an optional constituent. No particular limitation is imposed on (MB) insofar as it is a monomer copolymerizable with a monomer represented by (MF1) or (MF2) or a monomer forming a constituent represented by (MA). It can be selected as needed from various standpoints such as adhesion to a base material, Tg (contributing to the film hardness) of a polymer, solubility in solvent, transparency, slipperiness, and dust resistance/antifouling property.

Examples of the monomer forming (MB) include vinyl ethers such as methyl vinyl ether, ethyl vinyl ether, n-butyl vinyl ether, cyclohexyl vinyl ether, and isopropyl vinyl ether, and vinyl esters such as vinyl acetate, vinyl propionate, vinyl butyrate, and vinyl cyclohexanecarboxylate.

(MB) preferably contains a constituent having a polysiloxane structure. An antireflective film having improved slipperiness and antifouling property can be obtained when (MB) contains a polysiloxane structure, because the conductive polymer of the antireflective film can be distributed unevenly at the lower part (a part, in the low refractive index layer, closer to the support) of the film.

More specifically, (MB) preferably contains, in the main chain or side chain thereof, a polysiloxane repeating unit represented by the following formula (2).

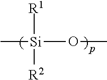

In the formula, each of R¹ and R² independently represents an alkyl group or an aryl group.

The alkyl group is preferably a C₁₋₄ alkyl group which may have a substituent. Specific examples include a methyl group, a trifluoromethyl group, and an ethyl group.

The aryl group is preferably a C₆₋₂₀ aryl group which may have a substituent. Specific examples include a phenyl group and a naphthyl group.

R¹ and R² are each preferably a methyl group or a phenyl group, with a methyl group being more preferred.

In the above formula, p stands for an integer from 2 to 500, preferably from 5 to 350, more preferably from 8 to 250.

The polymer having, in the side chain thereof, the polysiloxane structure represented by the formula (2) can be synthesized, for example, as described in J. Appl. Polym. Sci., 78, 1955(2000) and Japanese Patent Laid-Open No. 28219/1981, by using a process of introducing, into a polymer having a reactive group such as epoxy group, hydroxyl group, carboxyl group, or acid anhydride group, a polysiloxane (for example, “Silaplane” trade name; product of Chisso Corporation) having, on a terminal thereof, a reactive group (such as amino group, mercapto group, carboxyl group, or hydroxyl group reactive with the epoxy group or acid anhydride group of the polymer) or a process of polymerizing a polysiloxane-containing silicon macromer.

The polymer having, in the main chain thereof, the polysiloxane structure can be synthesized, for example, according to the process described in Japanese Patent Laid-Open No. 93100/1994 and using a polymer type initiator such as azo-containing polysiloxane amide (commercially available ones including “VPS-0501” and “VPS-1001”, each, trade name; product of Wako Pure Chemical Industries); a process of introducing a reactive group (such as mercapto group, carboxyl group, or hydroxyl group) derived from a polymerization initiator or a chain transfer agent into the terminal of a polymer and then reacting it with a polysiloxane containing a mono-terminal or bi-terminal reactive group (such as epoxy group or isocyanate group); or a process of copolymerizing a cyclic siloxane oligomer such as hexamethylcyclotrisiloxane by anionic ring-opening polymerization. Of these, the process utilizing an initiator having a polysiloxane partial structure is easy and preferable.

In the formula (1), a to e represent molar fractions of constituents and satisfy the following relationships: 0≦a≦70 and 0≦b≦70 with the proviso that 30≦a+b≦70, and 0≦c≦50, 5≦d≦50, and 0≦e≦50.

For reducing a refractive index, it is desired to increase the molar fraction (%) a+b of the components (MF1) and (MF2). In the conventional solution-based radical polymerization reaction, however, the limit value of a+b is from about 50 to 70% and it is generally difficult to introduce these components at a molar fraction exceeding this value. In the invention, the lower limit of a+b is preferably 40 or greater, more preferably 45 or greater.

Introduction of (MF3) also contributes to reduction in refractive index. As described above, the molar fraction c of the component (MF3) satisfies 0≦c≦50, preferably 5≦c≦20.

A total of the molar fractions of the fluorine-containing monomer components a to c falls within a range of preferably 40≦a+b+c≦90, more preferably 50≦a+b+c≦75.

When the fraction of the polymer unit represented by (MA) is too small, the cured film has only low strength. Particularly, in the invention, the molar fraction of the component (MA) falls within a range of preferably 5≦d≦40, especially preferably 15≦d≦30.

The molar fraction e of the optional constituent represented by (MB) falls within a range of preferably 0≦e≦50, more preferably 0≦e≦20, especially preferably 0≦e≦10.

In the invention, the fluorine-containing polymer (A) has, in the molecule thereof, preferably a functional group having high polarity from the standpoint of improving the surface state of the coated film, increasing conductivity, and improving scratch resistance of the film. The component (MB) therefore contains, in the molecule thereof, preferably a functional group having high polarity. It has, as the functional group having high polarity, preferably a hydroxyl group, an alkyl ether group, a silanol group, a glycidyl group, an oxetanyl group, a polyalkylene oxide group, or a carboxyl group, more preferably a hydroxyl group, an alkyl ether group, or a polyalkylene oxide group.

The molar fraction of a polymer unit having such a functional group is preferably from 0.1 to 15%, more preferably from 1 to 10%. The content of the polymer unit having such a functional group is preferably from 0.1 to 15 mass %, more preferably from 1 to 10 mass % in terms of a mass ratio relative to all the polymers.

By introducing the polar group within this range, good surface state of the coated film, improved conductivity, and high film strength can be achieved simultaneously. When a hydroxyl group is used as a curable functional group of the fluorine-containing polymer (A), however, the molar fraction of a hydroxyl group can be raised and it is preferably from 5 to 50%, more preferably from 10 to 30%.

In addition, a polysiloxane structure is preferably introduced into the fluorine-containing polymer (A) as described above. Introducing a polysiloxane structure in the fluorine-containing polymer (A) is effective for improving the conductivity by distributing an organic conductive polymer unevenly in the lower portion of the low refractive index layer without deteriorating the surface state of the coated film of the low refractive index layer or deteriorating the scratch resistance of the film. The content of the polysiloxane structure in the fluorine-containing polymer (A) is preferably from 0.5 to 15 mass %, more preferably from 1 to 10 mass %, each in terms of a mass ratio relative to all the polymers.

The fluorine-containing polymer (A) has a number average molecular weight of preferably from 1,000 to 1,000,000, more preferably from 5,000 to 500,000, still more preferably from 10,000 to 100,000.

The term “number average molecular weight” as used herein is a polystyrene-equivalent molecular weight determined by using a GPC analyzer, while using TSKgel GMHxL, TSKgel G4000HxL or TSKgel G2000HxL (each, trade name, product of Tosoh Corp.) as a column, THF as a solvent, and a differential refractometer as a detector.

Specific examples of the copolymer represented by the formula (1) will next be listed, but the invention is not limited to them. Table 1 shows combinations of monomers (MF1), (MF2), (MF3), (MA), and (MB) that form the fluorine-containing constituent of the formula (1) by polymerization. In the table, the unit of a to e is molar ratio (%) of the monomer of each component. In this table, with resepct to constituents other than EVE in the column (MB), the content pacentages (wt %) of the constituents indicates wt % of the respective constituents in the phole polymer and are written in order from the left following the molar ratio of EVE in the column e. The molecular weight in the table represents Mn.

TABLE 1

| | | | | | | | | | | | Molecular |
|---|---|---|---|---|---|---|---|---|---|---|---|
| | | | | | | | | | | | weight |
| | (MF1) | (MF2) | (MF3) | (MA) | (MB) | a | b | c | d | e | (×10⁴) |
| P-1 | HFP | — | — | (MA-33) | EVE | 50 | 0 | 0 | 20 | 30 | 3.1 |
| P-2 | HFP | — | — | (MA-33) | EVE/VPS-1001 | 50 | 0 | 0 | 20 | 30/4 wt % | 3.2 |
| P-3 | HFP | — | — | (MA-33) | EVE/FM-0721 | 50 | 0 | 0 | 20 | 30/4 wt % | 2.9 |
| P-4 | HFP | — | — | (MA-33) | EVE/VPS-1001/NE-30 | 50 | 0 | 0 | 20 | 30/4 wt %/1 wt % | 3.4 |
| P-5 | HFP | FPVE | — | (MA-33) | EVE/VPS-1001/NE-30 | 40 | 10 | 0 | 20 | 30/4 wt %/1 wt % | 3.2 |
| P-6 | HFP | FPVE | — | (MA-35) | EVE/VPS-1001 | 40 | 10 | 0 | 15 | 35/4 wt % | 2.7 |
| P-7 | HFP | FPVE | — | (MA-34) | EVE/VPS-1001/NE-30 | 40 | 10 | 0 | 25 | 25/4 wt %/1 wt % | 3.1 |
| P-8 | HFP | FPVE | MF3-1 | (MA-33) | EVE/NE-30 | 40 | 10 | 10 | 25 | 15/1 wt % | 3.3 |
| P-9 | HFP | FPVE | MF3-2 | (MA-33) | EVE/FM-0721 | 40 | 10 | 10 | 25 | 15/4 wt % | 3.4 |
| P-10 | HFP | — | — | (MA-37) | EVE/VPS-1001 | 50 | 0 | 0 | 25 | 25/4 wt % | 3.2 |
| P-11 | HFP | — | — | (MA-46) | — | 50 | 0 | 0 | 50 | 0 | 3.3 |
| P-12 | HFP | — | — | (MA-33)/(MA-46) | — | 50 | 0 | 0 | 15/35 | 0 | 3.2 |
| P-13 | HFP | — | — | (MA-33)/(MA-46) | EVE | 50 | 0 | 0 | 10/35 | 5 | 3.5 |
| P-14 | HFP | — | — | (MA-33)/(MA-46) | EVE/VPS-1001 | 50 | 0 | 0 | 10/35 | 5/4 wt % | 3.6 |
| P-15 | HFP | — | — | (MA-33)/(MA-46) | EVE/VPS-1001/NE-30 | 50 | 0 | 0 | 10/35 | 5/1 wt %/4 wt % | 3.4 |
| P-16 | HFP | FPVE | — | (MA-33)/(MA-46) | EVE/VPS-1001 | 40 | 10 | 0 | 10/35 | 5/4 wt % | 3.1 |
| P-17 | HFP | FPVE | MF3-1 | (MA-33)/(MA-46) | EVE/VPS-1001 | 40 | 10 | 5 | 5/35 | 5/4 wt % | 3.5 |
| P-18 | HFP | FPVE | MF3-1 | (MA-33)/(MA-46) | EVE/FM-0721/NE-30 | 40 | 10 | 5 | 5/35 | 5/1 wt %/4 wt % | 3.0 |
| P-19 | HFP | — | — | (MA-35)/(MA-58) | EVE/VPS-1001 | 50 | 0 | 0 | 5/35 | 10/4 wt % | 3.3 |
| P-20 | HFP | — | — | (MA-33)/(MA-56) | EVE/VPS-1001 | 50 | 0 | 0 | 5/35 | 10/4 wt % | 3.4 |

The abbreviations in the above table are as follows:
Component (MF1)

HFP: hexafluoropropylene
Component (MF2)

FPVE: perfluoropropyl vinyl ether
Component (MF3)

MF3-1: CH₂═CH—O—CH₂CH₂—O—CH₂(CF₂)₄H

MF3-2: CH₂═CH—O—CH₂CH₂(CF₂)₈F
Component (MB)

EVE: ethyl vinyl ether

“VPS-1001: azo-containing polydimethylsiloxane, molecular weight of the polysiloxane moiety: about 10000, product of Wako Pure Chemical Industries

“FM-0721”: Methacryloyl-modified dimethylsiloxane, average molecular weight: 5000, product of Chisso Corporation

“NE-30”: reactive nonionic emulsifier, containing an ethylene oxide moiety, product of ADEKA CORPORATION

When the fluorine-containing polymer (A) contains, as a crosslinking group, a silyl group (hydrolyzable silyl group) having a hydrolyzable group, a known acid or base catalyst may be added as a catalyst for sol-gel reaction. The amount of such a curing catalyst is not determined and it varies, depending on the kind of the catalyst or difference in the curing reaction site. Usually, it is preferably from about 0.1 to 15 mass %, more preferably form about 0.5 to 5 mass % based on the total solid content of the coating composition.

When the fluorine-containing polymer (A) contains a hydroxyl group as a crosslinking group, the low-refractive-index layer composition in the invention contains preferably a compound (curing agent) reactive with the hydroxyl group in the fluorine-containing polymer.

The curing agent has preferably two or more, more preferably four or more sites reactive with a hydroxyl group.

No particular limitation is imposed on the structure of the curing agent insofar as it has the above-described number of functional groups reactive with a hydroxyl group. Examples include polyisocyanates, partial condensates of an isocyanate compound, multimers, adducts with a polyhydric alcohol or with a low-molecular-weight polyester film, block polyisocyanate compounds obtained by blocking an isocyanate group with a blocking agent such as phenol, aminoplasts, and polybasic acids or anhydrides thereof.

As the curing agent, aminoplasts, which undergo crosslinking reaction with a hydroxyl-containing compound under acidic conditions, are preferred from the standpoint that they can satisfy storage stability and activity of the crosslinking reaction simultaneously and the film formed using it has adequate strength. The aminoplast is a compound that has an amino group reactive with a hydroxyl group contained in the fluorine-containing polymer, that is, a hydroxyalkylamino group or an alkoxyalkylamino group or has a carbon atom adjacent to a nitrogen atom and substituted by an alkoxy group. Specific examples include melamine compounds, urea compounds, and benzoguanamine compounds.

The melamine compound is typically known as a compound having a skeleton in which a nitrogen atom has been bonded to a triazine ring. Specific examples include melamine, alkylated melamine, methylol melamine and alkoxylated methyl melamine. In particular, methylolated melamine and alkoxylated methyl melamine, that can be obtained by reacting melamine and formaldehyde under a basic conditions, and derivatives thereof are preferred, with alkoxylated methyl melamines being particularly preferred from the standpoint of storage stability. Methylolated melamine and alkoxylated melamine are not particularly limited and various resins are usable such as those obtained by processes described in, for example, “Plastic Zairyou Kouza (8) Urea-melamine resins” (published by Nikkan Kogyo Shimbun).

Among the urea compounds, in addition to urea, polymethylolated urea, an alkoxylated methylurea which is a derivative thereof, and compounds having a glycoluril skeleton or a 2-imidazolidinone skeleton, which is a cyclic urea structure, are also preferred. As amino compounds such as the urea derivatives, various resins described in the above “Urea-melamine resins” may be utilized.

Examples of the compound preferred as the curing agent include melamine compounds and glycoluril compounds in consideration of the compatibility with the fluorine-containing polymer. Of these, compounds having, in the molecule thereof, a nitrogen atom and at the same time, having two or more carbon atoms each substituted with an alkoxy group adjacent to the nitrogen atom are preferred as the curing agent from the standpoint of reactivity. Of these, compounds have a structure represented by following formula H-1 or H-2, or a partial condensates thereof are especially preferred.

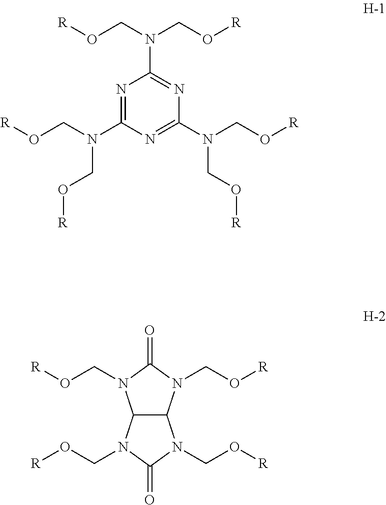

In the formula, R represents a C₁₋₆ alkyl group or a hydroxyl group.

The aminoplast is added to the fluorine-containing polymer in an amount of from 1 to 50 parts by mass, preferably from 3 to 40 parts by mass, still more preferably from 5 to 30 parts by mass, based on 100 parts by mass of the fluorine-containing polymer. Amounts of 1 part by mass or greater are preferred because a thin film obtained using it has sufficient durability, while amounts not greater than 50 parts by mass are preferred because a low refractive index can be maintained.

For the reaction between the fluorine-containing polymer having a hydroxyl group and the curing agent, using a curing catalyst is preferred. In this system, an acid promotes curing so that an acidic substance is preferred as the curing catalyst. Addition of an ordinarily used acid however inevitably causes the crosslinking reaction to proceed even in a coating solution and may be a cause for troubles (such as unevenness and cissing). It is therefore more preferred to add, as the curing catalyst, a compound that generates an acid when heated or a compound that generates an acid when exposed to light in order to achieve both storage stability and curing activity in a thermosetting system. Specific compounds are described in the paragraphs from [0220] to [0230] of Japanese Patent Laid-Open No. 2007-298974.

The content of the fluorine-containing polymer in the low-refractive-index layer composition is preferably from 10 to 90 mass %, more preferably 15 to 60 mass %, still more preferably 18 to 50 mass %, based on the total solid content of the composition. The content of the fluorine-containing polymer in the low refractive index layer is preferably the same ranges based on the total solid content of the layer.

### [(B) Conductive Polymer Composition]

The conductive polymer composition in the invention contains a π-conjugated conductive polymer and an anion group-containing polymer dopant. This conductive polymer composition is hydrophobized and preferably contains an organic solvent and forms a uniform solution as a whole.

The term “hydrophobized” means that after the hydrophobization, the conductive polymer composition shows at least 1.0 mass % (solid content) solubility at 20° C. in an organic solvent having a water content of 5 mass % or less and a relative permittivity of from 2 to 30. The relative permittivity is a value as measured at 20° C. The term “shows solubility” means that the conductive polymer composition (the π-conjugated conductive polymer and the polymer dopant) is dissolved in a solvent in a single molecule state, dissolved in an associated state of a plurality of single molecules, or dispersed as particles having a particle size of 300 nm or less. The term “organic solvent” means a compound that, after application and drying of the coating composition of the invention, is evaporated and removed substantially from a coated film.

In the invention, an antireflective film having a low surface resistivity is formed by using a composition obtained by making soluble a π-conjugated conductive polymer, which has conventionally been dissolved in a solvent composed mainly of water due to high hydrophilicity, in the organic solvent specified above by means of hydrophobization which will be described later, addition of a compound (solubilizing agent) enhancing the affinity with an organic solvent if necessary or addition of a dispersing agent in an organic solvent; and mixing the resulting conductive polymer with the fluorine-containing polymer (A).

Components contained in the conductive polymer composition of the invention will next be described.

### (π-Conjugated Conductive Polymer)

The π-conjugated conductive polymer is not particularly limited insofar as it is an organic polymer having a main chain composed of a π-conjugated system. The π-conjugated conductive polymer is preferably a π-conjugated heterocyclic compound or a derivative thereof because has high conductivity, excellent compound stability, and low color.

Examples of the π-conjugated conductive polymer include polypyrroles, polythiophenes, polyacetylenes, polyphenylenes, poly(phenylene vinylene)s, polyanilines, polyacenes, and poly(thiophene vinylene)s. From the standpoint of stability of the polymer in the air, polypyrroles, polythiophenes, and polyanilines are preferred, with polythiophenes and polyanilines (more specifically, polythiophene, polyaniline, polythiophene derivatives, and polyaniline derivatives) being more preferred.

The π-conjugated conductive polymer is able to have adequate conductivity and compatibility with a binder resin even in an unsubstituted form, but in order to enhance the conductivity and compatibility further, it is preferred to introduce a functional group such as alkyl group, carboxyl group, sulfo group, alkoxyl group, or hydroxyl group into the π-conjugated conductive polymer.

Specific examples of the π-conjugated conductive polymer include polypyrroles such as polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3 -ethoxypyrrole), poly(3-butoxypyrrole), poly(3-methyl-4-hexyloxypyrrole);

polythiophenes such as polythiophene, poly(3-methylthiophene), poly(3-ethylthiophene), poly(3-propylthiophene), poly(3-butylthiophene), poly(3-hexylthiophene), poly(3-heptylthiophene), poly(3 -octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3-methyl-4-methoxythiophene), poly(3,4-ethylenedioxythiophene), poly(3-methyl-4-ethoxythiophene), poly(3-carboxythiophene), poly(3-methyl-4-carboxythiophene), poly(3-methyl-4-carboxyethylthiophene), and poly(3-methyl-4-carboxybutylthiophene); and

polyanilines such as polyaniline, poly(2-methylaniline), poly(3-isobutylaniline), poly(2-anilinesulfonic acid), and poly(3-anilinesulfonic acid).

### (Uneven Distribution of π-Conjugated Conductive Polymer)

A fluorine atom has a high bond energy with a carbon atom and is therefore highly stable, and in addition it shows a low polarizability (dynamic polarizability) at which external induction is not caused easily. A fluorine-containing polymer has therefore a reduced refractive index and a reduced dielectric constant. Further, a low polarizability means that an intermolecular force is weak. Fluorine-containing compounds have lower surface tension than the other compounds and are likely to exist mainly near the surface.

A fluorine-containing polymer and a conductive polymer are used for the low refractive index layer of the antireflective film of the invention so that for example, after the low-refractive-index layer containing these polymers is applied onto a support and the organic solvent is dried, the fluorine-containing polymer is distributed mainly on the upper side (far side from the support) in the coated film due to its low surface energy. The π-conjugated conductive polymer can therefore be distributed mainly on the lower side (side closer to the support) in the coated film, which leads to development of excellent conductivity. In addition, because of the uneven distribution of the conductive polymer, the content of the conductive polymer can be reduced and as a result, an antireflective film excellent in the surface state of the coated film, cost, film strength, and reflectance can be obtained.

The degree of uneven distribution in the lower part of the coated film can be controlled by the structure of each component in the coating composition, the composition ratio of the components, or the like and the control method has already been described above. The degree of the uneven distribution in the lower part (lower-part uneven distribution) can be determined in accordance with the following formula:

Lower-part uneven distribution=[mass of conductive polymer present in a region from the center to the support in low refractive index layer]÷[total mass of conductive polymer present in the entirety of low refractive index layer]×100 (%)

The lower-part uneven distribution is preferably from 55 to 100 (%); more preferably from 60 to 100 (%), most preferably from 70 to 100 (%).

In the invention, when a coating composition containing the fluorine polymer and the conductive polymer is applied and the solvent is dried off, and lower-part uneven distribution proceeds due to the structure of the fluorine polymer or composition of the additive also present in the composition, the low refractive index layer sometimes seems to have a layer composition separated into two layers different in refractive index. Even in such a case, the entirety of the coated film formed from the coating composition for forming a low refractive index layer is called “low refractive index layer”.

### (Anion Group-Containing Polymer Dopant)

Examples of the anion group-containing polymer dopant (which may also be called “polyanion dopant”) include polymers having at least any one of structures selected from substituted or unsubstituted polyalkylenes, substituted or unsubstituted polyalkenylenes, substituted or unsubstituted polyimides, substituted or unsubstituted polyamides, and substituted or unsubstituted polyesters and containing an anion group-containing structural unit.

The term “polyalkylenes” means polymers having a main chain composed of methylene repeating units. Examples of the polyalkylenes include polyethylene, polypropylene, polybutene, polypentene, polyhexene, polyvinyl alcohol, polyvinyl phenol, poly(3,3,3-trifluoropropylene), polyacrylonitrile, polyacrylate, and polystyrene.

The term “polyalkenylenes” means polymers having a main chain composed of a structural unit containing an unsaturated double bond (vinyl group).

Examples of the polyimides include polyimides composed of an acid anhydride such as pyromellitic dianhydride, biphenyltetracarboxylic dianhydride, benzophenonetetracarboxylic dianhydride, or 2,2′-[4,4′-di(dicarboxyphenyloxy)phenyl]propane dianhydride and a diamine such as oxydiamine, paraphenylenediamine, metaphenylenediamine, or benzophenonediamine.

Examples of the polyamides include polyamide 6, polyamide 6,6, and polyamide 6,10.

Examples of the polyesters include polyethylene terephthalate and polybutylene terephthalate.

When the polyanion dopant has a substituent, examples of the substituent include alkyl groups, hydroxyl groups, amino groups, a carboxy group, a cyano group, phenyl groups, phenol groups, ester groups, and alkoxy groups. In consideration of the solubility in organic solvents, heat resistance, and compatibility with binder resins, alkyl groups, hydroxyl groups, phenol groups, and ester groups are preferred.

Examples of the alkyl groups include linear alkyl groups such as methyl, ethyl, propyl, butyl, isobutyl, t-butyl, pentyl, hexyl, octyl, decyl, and dodecyl and cycloalkyl groups such as cyclopropyl, cyclopentyl, and cyclohexyl.

Examples of the hydroxyl groups include hydroxyl groups bonded to the main chain of the polyanion dopant directly or via another functional group. Examples of the another functional group include C₁₋₇ alkyl groups, C₂₋₇ alkenyl groups, amide groups, and imide groups. The hydroxyl group is substituted at the terminal or in these functional groups.

Examples of the amino groups include amino groups bonded to the main chain of the polyanion dopant directly or via another functional group. Examples of the another functional group include C₁₋₇ alkyl groups, C₂₋₇ alkenyl groups, amide groups, and imide groups. The amino group is substituted at the terminal of or in these functional groups.

Examples of the phenol groups include phenol groups bonded to the main chain of the polyanion dopant directly or via another functional group. Examples of the another functional group include C₁₋₇ alkyl groups, C₂₋₇ alkenyl groups, amide groups, and imide groups. The phenol group is substituted at the terminal of or in these functional groups.

Examples of the ester groups include alkyl ester groups and aromatic ester groups each bonded to the main chain of the polyanion dopant directly or via another functional group.

As the anion groups of the polyanion dopant, any groups that are capable of causing oxidative doping to the π-conjugated conductive polymer compound may be used and examples include a sulfuric acid group, a phosphoric acid group, a sulfo group, a carboxy group, and a phospho group, of which —O—SO₃—X⁺, —SO₃—X⁺, and —COO—X⁺ (in which X⁺ represents a hydrogen ion or an alkali metal ion) are preferred.

Of these, —SO₃—X⁺, and —COO—X⁺ are more preferred from the standpoint of a doping ability to the π-conjugated conductive polymer.

Of the above-described polyanion dopants, polyisoprene sulfonic acid, copolymers containing polyisoprene sulfonic acid, polysulfoethyl methacrylate, copolymers containing polysulfoethyl methacrylate, poly(4-sulfobutyl methacrylate), copolymers containing poly(4-sulfobutyl methacrylate), polymethallyloxybenzene sulfonic acid, copolymers containing polymethallyloxybenzene sulfonic acid, 2-acrylamido-methylpropanesulfonic acid, copolymers containing 2-acrylamido-methylpropanesulfonic acid, polystyrenesulfonic acid, and copolymers containing polystyrenesulfonic acid are preferred.

In addition, as a component copolymerizable with the anion group, it is preferred to use a component having the following structure in order to improve the solubility in organic solvents: polyalkylene glycol structure, polystyrene derivative structure, poly(meth)acrylic acid derivative structure, poly(meth)acrylonitrile derivative structure, and polyether structure.

The degree of polymerization of the polyanion dopant is preferably in a range from 10 to 100,000 monomer units, and from the viewpoints of solubility in solvents and conductivity, is more preferably in a range from 50 to 10,000 monomer units.

The content of the polyanion dopant is preferably in a range from 0.1 to 10 mol, more preferably from 1 to 7 mol, per mol of the π-conjugated conductive polymer. The number of mol is defined by the number of structural units derived from the anion group-containing monomer constituting the polyanion dopant and the number of structural units derived from the monomer such as pyrrole, thiophene or aniline constituting the π-conjugated conductive polymer. When the content of the polyanion dopant is less than 0.1 mol per mol of the π-conjugated conductive polymer, the effect of doping to the π-conjugated conductive polymer tends to weaken and conductivity may be inadequate. Moreover, the dispersibility and solubility in solvents also deteriorate, making it difficult to obtain a uniform dispersion. On the other hand, when the content of the polyanion dopant exceeds 10 mol, the content of the π-conjugated conductive polymer is reduced, making it difficult to achieve satisfactory conductivity.

A total content of the π-conjugated conductive polymer and the polyanion dopant in the low-refractive-index layer composition is preferably from 0.05 to 5 mass %, more preferably from 0.5 to 4.0 mass % based on the total mass of the total solid content and the solvent in the composition. When the total content of the π-conjugated conductive polymer and the polyanion dopant is 0.05 mass % or greater, sufficient conductivity can be achieved, while the total content not greater than 5 mass % makes it difficult to cause gelation or deterioration in the surface state of the coated film.

The content of each of the π-conjugated conductive polymer and the anion group-containing polymer dopant is preferably from 1 mass % to 60 mass %, more preferably from 2 mass % to 30 mass %, each based on the total solid content of the low refractive index layer. Contents of the π-conjugated conductive polymer of 1 mass % or greater make it possible to provide an antireflective film having the common logarithm log (SR) of surface resistivity SR (Ω/sq) of 13 or less and having excellent dust resistance. Contents of the π-conjugated conductive polymer not greater than 60 mass % make it possible to provide an antireflective film having a sufficiently reduced reflectance and having a low refractive index layer with improved strength.

The refractive index of the π-conjugated conductive polymer is usually not lower than that of a polyfunctional fluorine-containing monomer and it has a refractive index of from about 1.48 to 1.65, with that having a refractive index of 1.60 or less being preferred.

The molecular weight of the π-conjugated conductive polymer is preferably from 1,000 to 1,000,000, more preferably from 5,000 to 500,000. When the conductive polymer is in the form of particles, the average particle size of it is preferably from 5 to 300 nm, more preferably from 10 to 150 nm. The particles may be either monodispersed or polydispersed.

No particular limitation is imposed on the combination of the π-conjugated conductive polymer and the polyanion dopant, examples include polyethylenedioxythiophene/polystyrene sulfonic acid (PEDOT/PSS), polyethylenedioxythiophene/polyisoprene sulfonic acid, polyethylenedioxythiophene/2-acrylamide-methylpropane sulfonic acid, polyaniline/polystyrene sulfonic acid, polyaniline/polyisoprene sulfonic acid, polyaniline/2-acrylamido-methylpropane sulfonic acid, polypyrrole/polystyrene sulfonic acid, polypyrrole/polyisoprene sulfonic acid, and polypyrrole/2-acrylamido-methylpropane sulfonic acid, and copolymers containing these components.

Of these, polyethylenedioxythiophene/polystyrene sulfonic acid (PEDOT/PSS), polyethylenedioxythiophene/polyisoprene sulfonic acid, and polyaniline/2-acrylamido-methylpropanesulfonic acid, and copolymers containing these components are preferred.

Examples of the commercially-available hydrophobized conductive polymer composition containing the π-conjugated conductive polymer and the anion group-containing polymer dopant include “SEPLEGYDA SAS-PD”: a polythiophene dispersion (solid content ratio: 4.2%) (product of Shin-Etsu Polymer) and “EL Coat UVH515”: hydrophobized polythiophene (solid content: 2.7%) [product of Idemitsu Technofine].

### (Hydrophobization Treatment of Conductive Polymer Composition)

In the invention, the conductive polymer composition should be subjected to hydrophobization treatment from the standpoint of improving the solubility of the conductive polymer composition in organic solvents or improving the affinity with the fluorine-containing polymer. Hydrophobization treatment is performed, for example, by modifying the anion group of the polyanion dopant, thereby hydrophobizing it.

A first hydrophobization method is to esterify, etherify, acetylate, tosylate, tritylate, alkyl-silylate, or alkyl-carbonylate the anion group. Of these, esterification and etherification are preferred. When hydrophobization is achieved by esterification, the anion group of the polyanion dopant is chlorinated with a chlorinating agent, followed by esterification with an alcohol such as methanol or ethanol. Alternatively, the anion group is esterified with a sulfo group or carboxyl group by using a compound having a hydroxyl group or a glycidyl group and further having an unsaturated double bonding group.

In the invention, various conventionally known methods can be used and some of them are described specifically in Japanese Patent Laid-Open No. 2005-314671 and Japanese Patent Laid-Open No. 2006-28439.

A second hydrophobization method is to couple a basic compound to the anion group of the polyanion dopant. The basic compound is preferably an amine compound such as primary amine, secondary amine, tertiary amine or aromatic amine. Specific examples include primary to tertiary amines substituted with a C₁₋₂₀ alkyl group, and imidazole and pyridine substituted with a C₁₋₂₀ alkyl group. The molecular weight of the amine is preferably from 50 to 2000, more preferably from 70 to 1000, most preferably from 80 to 500 for improving the solubility in organic solvents.

The amount of the amine compound serving as a basic hydrophobizing agent is preferably from 0.1 to 10.0 molar equivalents, more preferably from 0.5 to 2.0 molar equivalents, especially preferably from 0.85 to 1.25 molar equivalents, each with respect to the anion group of the polyanion dopant not contributing to the doping of the π-conjugated conductive polymer. The solubility in organic solvents, conductivity, and strength of the coated film can be satisfied by adjusting the amount of the amine compound to fall in the above-described range.

Various conventionally known methods can be used in the present invention and some of them are described specifically in Japanese Patent Laid-Open No. 2008-115215 and Japanese Patent Laid-Open No. 2008-115216.

### (Organic Solvent Usable for Conductive Polymer Composition)

The conductive polymer composition uses an organic solvent as needed. Organic solvents having a water content of 5 mass % or less and a relative permittivity of from 2 to 30 are preferably used for the conductive polymer composition. In addition, the conductive polymer, the polymer dopant, and the like of the conductive polymer composition are preferably dispersed in an organic solvent having a relative permittivity of from 2 to 30. It is also preferred that the conductive polymer and the polymer dopant of the conductive polymer composition have a solubility of at least 1.0 mass % in an organic solvent having a water content of 5 mass % or less and a relative permittivity of from 2 to 30. It is more preferred that they have a solubility of at least 5.0 mass % in the organic solvent.

As such an organic solvent, for example, alcohols, aromatic hydrocarbons, ethers, ketones, and esters are suited. The following are examples of these compounds and the numeral in the parentheses is the relative permittivity of the compound.

Examples of the alcohols include monohydric alcohols and dihydric alcohols. The monohydric alcohols are preferably saturated aliphatic alcohols having from 2 to 8 carbon atoms. Specific examples of the alcohols include ethyl alcohol (25.7), n-propyl alcohol (21.8), i-propyl alcohol (18.6), n-butyl alcohol (17.1), sec-butyl alcohol (15.5), and tert-butyl alcohol (11.4). Specific examples of the aromatic hydrocarbon include benzene (2.3), toluene (2.2), and xylene (2.2); those of the ethers include tetrahydrofuran (7.5), ethylene glycol monomethyl ether (16), ethylene glycol monomethyl ether acetate (8), ethylene glycol monoethyl ether (14), ethylene glycol monoethyl ether acetate (8), and ethylene glycol monobutyl ether (9); those of the ketones include acetone (21.5), diethyl ketone (17.0), methyl ethyl ketone (15.5), diacetone alcohol (18.2), methyl isobutyl ketone (13.1), and cyclohexanone (18.3); and those of the esters include methyl acetate (7.0), ethyl acetate (6.0), propyl acetate (5.7), and butyl acetate (5.0).

The relative permittivity of the organic solvent is more preferably from 2.3 to 24, still more preferably from 4.0 to 21, especially preferably from 5.0 to 21 from the standpoint that it can dissolve and disperse therein both the conductive polymer composition and the fluorine-containing polymer. For example, i-propyl alcohol, acetone, propylene glycol monoethyl ether, cyclohexanone, and methyl acetate are preferred, with i-propyl alcohol, acetone, and propylene glycol monoethyl ether being especially preferred.

As the organic solvent, two or more of them having a relative permittivity of from 2 to 30 may be used in combination. Although an organic solvent or water (5 mass % or less) having a relative permittivity exceeding 30 may also be used in combination, it is preferred that the mass-average dielectric constant of the two or more organic solvents or water, in the mixed organic solvent system including the organic solvent having a relative permittivity of from 2 to 30, does not exceed 30. By controlling the relative permittivity to fall in this range, a coating solution in which both the π-conjugated conductive polymer composition of the invention and the fluorine-containing polymer of the invention have been dissolved and dispersed can be formed and an optical film having a good surface state can be formed.

The term “relative permittivity” in the invention means a dielectric constant relative to that of vacuum. It can be measured according to the transformer bridge method by using a dielectric constant measuring apparatus “TRS-10T” (trade name; product of Ando Denki Co., Ltd.). It is measured at 20° C. and a frequency of 10 kHz.

### (Solubilizing Agent)

A solubilizing agent may be incorporated in the conductive polymer composition.

Using a solubilizing agent promotes solubilization of the π-conjugated conductive polymer in an organic solvent having a low water content and further improves the state of the surface to which the low-refractive-index layer has been applied or increase the strength of the cured film.

The solubilizing agent is preferably a copolymer having a hydrophilic site, a hydrophobic site, and a site containing an ionizing radiation curable functional group, particularly preferably a block type or graft type copolymer having the above sites as respective segments. Such a copolymer can be obtained by living anion polymerization, living radical polymerization or polymerization using a macromonomer having the above sites.

The solubilizing agents are described, for example, in the paragraphs from [0022] to [0038] of Japanese Patent Laid-Open No. 2006-176681.

When the solubilizing agent is the copolymer, a mass ratio of the hydrophilic polymer unit to the hydrophobic polymer unit is preferably from 1:99 to 60:40, more preferably from 2:98 to 30:70. The using amount of the solubilizing agent is preferably from 1 to 100 mass %, more preferably from 2 to 70 mass %, most preferably from 5 to 50 mass %, each based on the total amount of the π-conjugated conductive polymer and the polyanion dopant.

### (Low Molecular Dopant)

Using a low molecular dopant in combination with the polyanion dopant is also preferred in the invention. The low molecular dopant is preferably a compound having, in the molecule thereof, two or less anion groups and having a molecular weight of 1000 or less. The low molecular dopant contains particularly preferably at least one compound selected from the group consisting of 2-acrylamido-2-methyl-1-propanesulfonic acid, 1,1-oxybis-tetrapropylene derivative sodium benzenesulfonate, and vinylallylsulfonic acid.

### (Preparation Process of Conductive Polymer Composition)

In the conductive polymer composition of the invention, the π-conjugated conductive polymer and the polyanion dopant are preferably dissolved and dispersed in the organic solvent. The water content of the organic solvent is preferably 5 mass % or less.

Such a conductive polymer composition can be prepared by using various processes, but the following two processes are preferred.

First one is to prepare a conductive polymer composition by polymerizing a π-conjugated conductive polymer in water in the presence of a polyanion dopant, treating the resulting polymer with the solubilizing agent or basic hydrophobizing agent as needed, and the substituting the water with an organic solvent.

Second one is to prepare a conductive polymer composition by polymerizing a π-conjugated conductive polymer in water in the presence of a polyanion dopant, treating the resulting polymer with the solubilizing agent or basic hydrophobizing agent as needed, evaporating the water to dryness, and then adding an organic solvent to the residue to solubilize it.

In the above process, the amount of the solubilizing agent is preferably from 1 to 100 mass %, more preferably from 2 to 70 mass %, most preferably from 5 to 50 mass %, each based on the total amount of the π-conjugated conductive polymer and the polyanion dopant.

A method of substituting the water with an organic solvent in the first process is conducted preferably by adding a solvent having high miscibility with water such as ethanol, isopropyl alcohol, or acetone to form a uniform solution and then removing water by ultrafiltration. Or, it can also be conducted by reducing a water content to some extent with a solvent having high miscibility with water, mixing with a more hydrophobic solvent, and removing a highly volatile component under reduced pressure to control the solvent composition. If sufficient hydrophobization is performed with a basic hydrophobizing agent, it is also possible to add an organic solvent having limited miscibility with water to obtain separated two phases and extract the π-conjugated conductive polymer in the aqueous phase into the organic solvent phase.

Examples of the commercially-available hydrophobized conductive polymer composition containing the π-conjugated conductive polymer and the anion group-containing polymer dopant include “SEPLEGYDA SAS-PD” (trade name; product of Shin-Etsu Polymer) and “EL Coat UVH515” (trade name; product of Idemitsu Technofine].

[(C) Monomer Having, in a Molecule Thereof, Two or More (meth)acryloyl Groups]

The low-refractive-index-layer composition of the invention contains preferably a monomer having, in a molecule thereof, two or more (meth)acryloyl groups.

Increasing a fluorine content of the fluorine-containing polymer in order to reduce the refractive index of the low refractive index layer tends to reduce the crosslinking group density in the film. The film thus obtained has reduced strength and poor scratch resistance. When the fluorine-containing polymer and the conductive polymer are used in combination in order to impart the film with conductivity, affinity with the conductive polymer is low because of a large difference in polarity between them. When a coating solution containing a solvent is applied and then dried to form a low refractive index layer, the coated film after curing tends to have reduced strength because of weak interfacial bonding between the conductive polymer and the fluorine polymer. In particular, in the antireflective film, when such a low refractive index layer is placed on the uppermost surface, it is likely to suffer from polymerization inhibition due to oxygen upon curing, which may lead to weaker curing.

Using a small amount of the monomer having (C), in a molecule thereof, two or more (meth)acryloyl groups in combination makes it possible to improve the affinity between the conductive polymer and the fluorine-containing polymer to enhance the strength and scratch resistance of the resulting film.

Specific examples of the monomer having two or more (meth)acryloyl groups include (meth)acrylic acid diesters of alkylene glycol such as neopentyl glycol diacrylate, 1,6-hexanediol di(meth)acrylate, and propylene glycol di(meth)acrylate;

(meth)acrylic acid diesters of polyoxyalkylene glycol, such as triethylene glycol di(meth)acrylate, dipropylene glycol di(meth)acrylate, polyethylene glycol di(meth)acrylate, and polypropylene glycol di(meth)acrylate;

(meth)acrylic acid diesters of polyhydric alcohol such as pentaerythritol di(meth)acrylate; and

(meth)acrylic acid diesters of ethylene oxide or propylene oxide adduct such as 2,2-bis{4-(acryloxy·diethoxy)phenyl}propane and 2-2-bis{4-(acryloxy·poly-propoxy)phenyl}propane.

Furthermore, epoxy(meth)acrylates, urethane(meth)acrylates, and polyester(meth)acrylates may also be preferably used as the photopolymerizable polyfunctional monomer.

Above all, esters of a polyhydric alcohol and (meth)acrylic acid are preferred, with polyfunctional monomers having, in a molecule thereof, three or more (meth)acryloyl groups being more preferred. Examples include pentaerythritol tetra(meth)acrylate, pentaerythritol tri(meth)acrylate, trimethylolpropane tri(meth)acrylate, ethylene-oxide-modified trimethylolpropane tri(meth)acrylate, propylene-oxide-modified trimethylolpropane tri(meth)acrylate, ethylene-oxide-modified phosphoric acid tri(meth)acrylate, trimethylolethane tri(meth)acrylate, ditrimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate, and caprolactone-modified tris(acryloxyethyl)isocyanurate.

Among these compounds, those having, in the molecule thereof, a hydroxyl group, an amide group, an ethylene oxide group, or a propylene oxy group are preferred. Compounds having such a functional group are excellent in affinity between the conductive polymer and the fluorine polymer so that they can improve the surface state of the coated film, enhance the hardness of the low refractive index layer, and improve the scratch resistance.

Specific examples of the polyfunctional acrylate compounds having a (meth)acryloyl group include compounds described in [0119] to [0121] of Japanese Patent Laid-Open No. 2009-098658.

The above-described compounds may be used either singly or in combination.

The amount of the monomer having a (meth)acryloyl group (C) is preferably in a range of from 0.1 to 50 mass %, more preferably in a range of from 1 to 30 mass %, particularly preferably in a range of from 3 o 20 mass % based on the solid content constituting the film. Controlling the using amount to fall in the above range is effective for increasing the hardness of the low refractive index layer itself, fixing an antifouling agent onto the surface layer of the low refractive index layer, and improving the interface adhesion with the adjacent layer.

### [(D) Inorganic Fine Particles]

In the invention, using inorganic fine particles for the low refractive index layer is preferred from the standpoint of reducing the low refractive index and improving the scratch resistance. Although no particular limitation is imposed on the inorganic fine particles insofar as they have an average particle size of from 1 to 200 nm, inorganic low refractive index particles are preferred from the standpoint of reduction in refractive index.

As the inorganic particles, fine particles such as magnesium fluoride or silica can be used because they have a low refractive index. In particular, silica fine particles are preferred from the standpoint of refractive index, dispersion stability, and cost. These inorganic particles have a size (primary size) of preferably from 1 to 200 nm, more preferably from 5 to 150 nm, still more preferably from 20 to 100 nm, most preferably from 40 to 90 nm.

When the particle size of the inorganic fine particles is too small, they are less effective for improving the scratch resistance. When the particle size is too large, minute irregularities appear on the surface of the low refractive index layer, which may deteriorate the appearance such as dense blackness or the integrated reflectance. The inorganic fine particles may be either crystalline or amorphous and may be monodisperse particles or may be even aggregate particles insofar as the predetermined particle size is satisfied. The shape is most preferably spherical but it may be indefinite.

The coating weight of the inorganic fine particles is preferably from 1 to 100 mg/m², more preferably from 5 to 80 mg/m², still more preferably from 10 to 60 mg/m². When the coating weight is too small, the effect of improving the scratch resistance decreases, while when it is excessively large, minute irregularities appear on the surface of the low refractive index layer, leading to deterioration in the appearance such as dense blackness or integrated reflectance.

### (Porous or Hollow Fine Particles)

In order to reduce the refractive index, the inorganic fine particles (D) are preferably porous inorganic fine particles or inorganic fine particles having a hollow therein. In particular, using silica fine particles having a hollow structure, that is, having a cavity inside of the fine particles is preferred. The void fraction of such particles is preferably from 10 to 80%, more preferably from 20 to 60%, most preferably from 30 to 60%. The void fraction of the hollow fine particles is preferably adjusted to fall within the above-described range from the standpoint of reducing the refractive index and maintaining the durability of the particles.

When the porous or hollow fine particles are silica fine particles, the refractive index of them is preferably from 1.10 to 1.40, more preferably from 1.15 to 1.35, most preferably from 1.15 to 1.30. The refractive index used here indicates a refractive index of the particles as a whole and does not mean a refractive index of only silica in the outer shell forming the hollow silica particles.

The coating weight of the porous or hollow silica is preferably from 1 to 100 mg/m², more preferably from 5 to 80 m g/m², still more preferably from 10 to 60 mg/m². When the coating weight is too small, the effect of reducing the refractive index or improving the scratch resistance decreases, while when it is excessively large, minute irregularities appear on the surface of the low refractive index layer, leading to deterioration in the appearance such as dense blackness or integrated reflectance.

When the particle size of the silica fine particles is too small, the proportion of the void portion decreases so that reduction of the refractive index cannot be expected. When it is excessively large, on the other hand, minute irregularities appear on the surface of the low refractive index layer and the appearance such as dense blackness or integrated reflectance may be deteriorated. The silica fine particles may be crystalline or amorphous and are preferably monodisperse particles. The shape is most preferably spherical but it may be indefinite.

As the hollow silica, two or more kinds different in average particle size may be used in combination. The average particle size of the hollow silica can be determined from the electron micrograph of it.

In the invention, the specific surface area of the hollow silica is preferably from 20 to 300 m²/g, more preferably from 30 to 120 m²/g, most preferably from 40 to 90 m²/g. The surface area can be determined by the BET method using nitrogen.

Void-free silica particles may be used in combination with the hollow silica. The particle size of the void-free silica is preferably 30 nm or greater but not greater than 150 nm, more preferably 35 nm or greater but not greater than 100 nm, most preferably 40 nm or greater but not greater than 80 nm.

Preferred modes of the inorganic fine particles and porous or hollow fine particles, preparation processes thereof, surface treatment method, and organosilane compounds and metal chelate compounds to be used in the surface treatment method are described in the paragraphs from [0033] to [0078] of Japanese Patent Laid-Open No. 2009-098658, which can be similarly applied to the invention.

### [(E) Fluorine-Containing Anti-Fouling Agent Having Ionizing Radiation Curable Functional Group]

To the low refractive index layer, a fluorine-containing antifouling agent and a lubricant are preferably added as needed in order to impart it with an antifouling property, water resistance, chemical resistance, slipperiness, and the like. The fluorine-containing antifouling agent preferably contains an ionizing radiation curable functional group from the viewpoint of inhibiting backside transfer of the fluorine-containing compound upon storage of the coated product in roll form and improving scratch resistance of the coated film. The fluorine-containing antifouling agent having an ionizing radiation curable functional group contains a fluorine-based compound having an ionization radiation curable functional group. Although no particular limitation is imposed on the ionizing radiation curable functional group, it is preferably a polymerizable unsaturated group. This makes it possible to inhibit backside transfer of the fluorine compound when the coated product is stored in roll form, to improve scratch resistance of the coated film, and improve durability against repeated wiping-off of a stain. The polymerizable unsaturated group is most preferably a methacryloyloxy group or an acryloyloxy group.

Specific examples of the fluorine-containing antifouling agent include compounds described in the paragraphs [0218] and [0219] of Japanese Patent Laid-open No. 2007-301970.

Compounds represented by the following formulas (F-1), (F-2) and (F-3) are preferred modes of the compound having, as the ionizing radiation curable functional group, a (meth)acryloyloxy group.

The compound of the first preferred mode is a compound represented by the following formula (F-1):

Rf(CF₂CF₂)ₙCH₂CH₂R₂OCOCR₁═CH₂ Formula (F-1)

In the above formula, Rf represents a fluorine atom or a C₁₋₁₀ fluoroalkyl group, R₁ represents a hydrogen atom or a methyl group, R₂ represents a single bond or an alkylene-containing group, n stands for an integer indicating the degree of polymerization, and the degree n of polymerization is k (k stands for any of integers 1 or greater).

Examples of the telomeric acrylate containing a fluorine atom in the formula (F-1) include partially or fully fluorinated alkyl ester derivatives of (meth)acrylic acids.

The following are specific examples of the compound represented by the formula (F-1) but the invention is not limited to them.

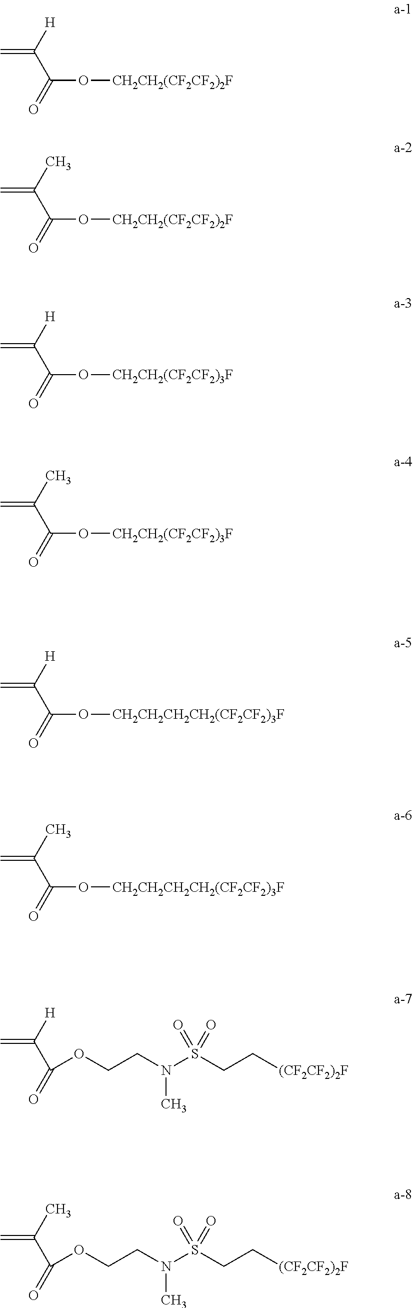

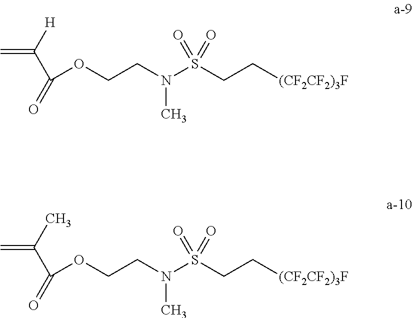

When telomerization is used upon synthesis, the compound represented by the formula (F-1) may comprise a plurality of fluorine-containing (meth)acrylic acid esters in which n of the group in the formula (F-1): Rf(CF₂CF₂)ₙR₂CH₂CH₂O— is each k, k+1, k+2, . . . , or the like, according to the telomerization condition, the separation condition of a reaction mixture, and the like.

A second preferred embodiment is a compound represented by the following formula (F-2).

F(CF₂)ₙO(CF₂CF₂O)ₘCF₂CH₂OCOCR═CH₂ Formula (F-2)

In the formula (F-2), R represents a hydrogen atom or a methyl group, m stands for an integer from 1 to 6, and n stands for an integer from 1 to 4.

The fluorine-containing monofunctional (meth)acrylate represented by the formula (F-2) can be obtained by reacting a fluorine-containing alcohol compound represented by the following formula (FG-2) with a (meth)acrylic acid halide.

F(CF₂)ₙO(CF₂CF₂O)ₘCF₂CH₂OH Formula (FG-2)

In the formula (FG-2), m stands for an integer from 1 to 6 and n stands for an integer from 1 to 4.

Specific examples of the fluorine-containing alcohol compound represented by the formula (FG-2) include compounds described in Japanese Patent Laid-Open No. 2007-114772. Preferably, 1H,1H-perfluoro-3,6,9-trioxadecan-1-ol is used.

Examples of the (meth)acrylic acid halide to be reacted with the fluorine-containing alcohol compound represented by the formula (FG-2) include (meth)acrylic acid fluoride, (meth)acrylic acid chloride, (meth)acrylic acid bromide, and (meth)acrylic acid iodide, but (meth)acrylic acid chloride is typically preferred from the viewpoint of easy availability.

The following are preferred specific examples of the compound represented by the formula (F-2), but it is not limited to them.

(b-1): F₉C₄OC₂F₄OC₂F₄OCF₂CHOCOCH═CH₂

(b-2): F₉C₄OC₂F₄OC₂F₄OCF₂CHOCOC(CH₃)═CH₂

As a third preferred mode, the following compounds represented by the formula (F-3) can be given.

(Rf)-[(W)-(RA)ₙ]ₘ Formula (F-3)

In the formula (F-3), Rf represents a fluoropolyether group or a perfluoropolyether group, W represents a linking group, and RA represents a (meth)acryl group, n stands for an integer from 1 to 3, and m stands for an integer from 1 to 3, with the proviso that n and m do not represent 1 simultaneously.

In the compound represented by the formula (F-3), W represents, for example, an alkylene, an arylene, or a heteroarylene, or a linking group obtained using these groups in combination. These linking groups may further contain carbonyl, carbonyloxy, carbonylimino, or sulfonamide, or a functional group obtained by using these groups in combination.

The following is a preferred structure of Rf.

F(CF(CF₃)CF₂O)ₚCF(CF₃)—

wherein, p stands for from 4 to 15 on average.

The number average molecular weight of the compound represented by the formula (F-3) is preferably from 400 to 5000, more preferably from 800 to 4000, most preferably from 1000 to 3000.

Preferred specific examples and synthesis process of the compound represented by the formula (F-3) are described in WO 05/008570.

Hereinbelow, F(CF(CF₃)CF₂O)ₚCF(CF₃)— in which p stands for from 6 to 7 on average is denoted as “HFPO—” and specific examples of the compound represented by the formula (F-3) will be given, but it is not limited to them.
(C-1): HFPO—CONH—C—(CH₂OCOCH═CH₂)₂CH₂CH₃
(C-2): HFPO—CONH—C—(CH₂OCOCH═CH₂)₂H
(C-3): 1:1 Michael addition polymerization product of HFPO—CONH—C₃H₆NHCH₃:trimethylolpropane triacrylate

### [The Other Additives]

### (Organosilane Compound)

To the low-refractive-index layer composition, an organosilane compound or a hydrolysate of the organosilane compound and/or a partial condensate thereof can be added. Specific modes of the organosilane compound are described in the paragraphs from [0033] to [0078] of Japanese Patent Laid-Open No. 2009-098658, which can be similarly applied to the invention.

### (Coating Solvent)

As the solvent to be used for the low refractive index layer or each of the other layers, various solvents selected, for example, from the standpoint whether the solvent can dissolve or disperse each component therein, readily provides a uniform surface state in the application step and drying step, can ensure liquid storability or has an appropriate saturated vapor pressure, may be used.

Two or more solvents may be used as a mixture. In particular, in view of the drying load, the mixture has, as a main component thereof, a solvent having a boiling point of 100° C. or less at room temperature and normal pressure and, in order to control the drying rate, contains a small amount of a solvent having a boiling point exceeding 100° C.

Examples of the solvents having a boiling point of 100° C. or less and a boiling point exceeding 100° C. include compounds described in Japanese Patent Laid-Open No. 2008-151866.

Preferred examples of the solvent having a boiling point of 100° C. or less include ketones and esters, with ketones being especially preferred. Of the ketones, 2-butanone (corresponding to MEK, boiling point: 79.6° C.) is especially preferred.

Preferred examples of the solvent having a boiling point exceeding 100° C. include cyclohexanone (boiling point: 155.7° C.), 2-methyl-4-pentanone (corresponding to MIBK, boiling point: 115.9° C.), and propylene glycol monomethyl ether acetate (PGMEA, boiling point: 146° C.).

Another preferred example using two or more organic solvents includes use of two solvents whose difference in boiling point is greater than a specified value. The difference of two solvents in boiling point is preferably 25° C. or greater, especially preferably 35° C. or greater, still more preferably 50° C. or greater. A large difference in boiling point facilitates uneven distribution of the organic conductive compound in the lower part and separation of a binder.

### [Preparation Process of Low Refractive Index Layer]

Conditions suited for curing of a curable functional group of each component used for the low refractive index layer can be selected. Preferred examples of them will next be described.

(A) System Using, in Combination, a Hydroxyl-Containing Fluorine-Containing Compound and a Compound Reactive with a Hydroxyl Group.

The curing temperature is preferably from 60 to 200° C., more preferably from 80 to 130° C., most preferably from 80 to 110° C. Curing is performed preferably at low temperatures when a support is likely to be deteriorated at high temperatures. Time necessary for thermal curing is preferably from 30 seconds to 60 minutes, more preferably from 1 minute to 20 minutes.

Particularly, when the low refractive index layer has, as an underlying layer thereof, an optical film constituting layer containing an ionizing radiation curable (meth)acrylate, a (meth)acrylate-containing compound is added to the low refractive index layer to reinforce the interfacial bonding between them. The preferable curing conditions will be described later, together with those of a system (B).

(B) System Using a Fluorine-Containing Compound Containing a (meth)acrylate Group

When the fluorine-containing compound contains a (meth)acrylate group, using a (meth)acrylate-containing compound further for the low refractive index layer is preferred from the standpoint of improving the strength of the coated film. Curing is achieved effectively by using, in combination, exposure to ionizing radiation and heat treatment before exposure, simultaneously with the exposure, or after the exposure.

The some patterns of a manufacturing step will be described below, but it is not limited to them.

In addition to the steps described below, a step of carrying out heat treatment simultaneously with the ionizing radiation curing is preferred.

(Heat treatment)

Table 2

| | Before exposure | → | Exposure | | After exposure |
|---|---|---|---|---|---|
| (1) | Heat treatment | → | Curing with | → | — |
| | | | ionizing radiation | | |
| (2) | Heat treatment | → | Curing with | → | Heat treatment |
| | | | ionizing radiation | | |
| (3) | — | → | Curing with | → | Heat treatment |
| | | | ionizing radiation | | |

(— means that no heat treatment is conducted)

In the invention, as described above, it is preferred to carry out the exposure to ionizing radiation in combination with the heat treatment. Although no particular limitation is imposed on the heat treatment insofar as it does not impair the constituent layers of an optical film including a support and the low refractive index layer, it is carried out at preferably from 60 to 200° C., more preferably from 80 to 130° C., most preferably from 80 to 110° C.

By increasing the temperature, the orientation or distribution of each component in the coated film can be adjusted or a photocuring reaction can be controlled. Each component has not been fixed before curing by using exposure to ionizing radiation or heat and orientation of each component occurs relatively speedily. After curing is started, however, each component is fixed and orientation occurs only partially. Time required for heat treatment is from 30 seconds to 24 hours, preferably from 60 seconds to 5 hours, most preferably from 3 minutes to 30 minutes, though it varies, depending on the molecular weight of the components used, interaction with another component, viscosity, or the like.

### (Ionization Radiation Exposure Conditions)

Although no particular limitation is imposed on the film surface temperature upon exposure to ionizing radiation, it is usually from 20 to 200° C., preferably from 30 to 150° C., most preferably from 40 to 120° C. from the standpoint of handling property and in-plane uniformity of the performance. The film surface temperature not greater than the upper limit is preferred because problems such as worsening of the surface state due to an excessive increase in fluidity of a lower molecular component in the binder or damage of the support due to heat. On the other hand, the film surface temperature of the lower limit or greater is preferred because a curing reaction proceeds sufficiently and the film has good scratch resistance.

### (Oxygen Concentration)

The oxygen concentration upon exposure to ionizing radiation is preferably 3% by volume or less, more preferably 1% by volume or less, still more preferably 0.1% by volume or less. By providing, immediately before or after a step of exposing to ionizing radiation at an oxygen concentration of 3% by volume or less, a step of keeping in an atmosphere having an oxygen concentration of 3% by volume or less, it is possible to accelerate curing of the film sufficiently and form a film excellent in physical strength and chemical resistance.

A low refractive index layer in the present invention means a layer having a refractive index of 1.50 or less. The refractive index of the low refractive index layer is preferably from 1.20 to 1.46, more preferably from 1.25 to 1.46, especially preferably from 1.30 to 1.46.

The thickness of the low refractive index layer is preferably from 50 to 300 nm, more preferably from 70 to 200 nm.

The haze of the low refractive index layer is preferably 3% or less, more preferably 2% or less, most preferably 1% or less.

The strength of the low refractive index layer is preferably H or greater, more preferably 2H or greater, most preferably 3H or greater in the pencil hardness test under a load of 500 g.

In order to improve the antifouling performance of the optical film, the contact angle of the surface relative to water is 90 degree or greater, more preferably 95 degree or greater, especially preferably 100 degree or greater.

### [Layer Constitution of Antireflective Film]

The antireflective film of the invention has, on a support, a low refractive index layer having a refractive index of 1.50 or less. The antireflective film may have a hard coat layer, which will be described later, in order to enhance the physical strength of the antireflective film. In this case, the hard coat layer is preferably located between the support and the low refractive index layer.

The antireflective film may have a high refractive index layer having a refractive index higher than 1.50 in order to reduce the reflectance further. Examples of the layer constitution in such a case include an antireflective film having, over a support or a hard coat layer thereon, two layers, that is, a high refractive index layer and a low refractive index layer stacked in the order of mention from the side of the support; and an antireflective film having three layers different in refractive index, that is, a medium refractive index layer (a layer having a refractive index higher than that of the support or hard coat layer but lower than that of a high refractive index layer), the high refractive index layer, and the low refractive index layer stacked in the order of mention from the side of the support. Each layer on the support can be formed in consideration of a refractive index, film thickness, the number of layers, the order of layers, and the like so as to reduce the reflectance as a whole by utilizing optical interference.

The following are more specific examples of the layer constitution of the antireflective film of the invention.
Support/low refractive index layer
Support/antiglare layer/low refractive index layer
Support/hard coat layer/low refractive index layer
Support/hard coat layer/antiglare layer/low refractive index layer
Support/hard coat layer/high refractive index layer/low refractive index layer
Support/hard coat layer/medium refractive index layer/high refractive index layer/low refractive index layer
Support/hard coat layer/antiglare layer/high refractive index layer/low refractive index layer
Support/hard coat layer/antiglare layer/medium refractive index layer/high refractive index layer/low refractive index layer
Support/antiglare layer/high refractive index layer/low refractive index layer
Support/antiglare layer/medium refractive index layer/high refractive index layer/low refractive index layer

The low refractive index layer in the invention has an antistatic effect. In addition to the low refractive index layer having an antistatic effect, another antistatic layer (layer containing a conducting material) may sometimes be formed. In this case, the another antistatic layer may be provided at any position but can be provided at the following position.
Support/antistatic layer/low refractive index layer
Support/antiglare layer/antistatic layer/low refractive index layer
Support/hard coat layer/antiglare layer/antistatic layer/low refractive index layer
Support/hard coat layer/antistatic layer/antiglare layer/low refractive index layer
Support/hard coat layer/antistatic layer/high refractive index layer/low refractive index layer
Support/antistatic layer/hard coat layer/medium refractive index layer/high refractive index layer/low refractive index layer
Antistatic layer/support/hard coat layer/medium refractive index layer/high refractive index layer/low refractive index layer
Support/antistatic layer/antiglare layer/medium refractive index layer/high refractive index layer/low refractive index layer
Antistatic layer/support/antiglare layer/medium refractive index layer/high refractive index layer/low refractive index layer,
Antistatic layer/support/antiglare layer/high refractive index layer/low refractive index layer/high refractive index layer/low refractive index layer.

The layer constitution of the antireflective film of the invention is not limited to the above-described ones insofar as the resulting film can have reduced reflectance by utilizing the optical interference.

The high refractive layer may be a light diffusive layer having no antiglare property. The antistatic layer is preferably a layer containing conductive polymer particles or metal oxide fine particles (such as ATO, ITO), which layer can be formed by coating or atmospheric pressure plasma treatment. When an antifouling layer is provided, it can be provided on the uppermost layer of the above constitutions.

### [High Refractive Index Layer]

The high refractive index layer contains preferably an inorganic filler composed of an oxide of at least one metal selected from titanium, zirconium, aluminum, indium, zinc, tin, and antimony and having an average particle size of preferably 0.2 μm or less, more preferably 0.1 μm or less, still more preferably 0.06 μm or less, in order to increase the refractive index of the layer and reduce the cure shrinkage.

The high refractive index layer, similar to the hard coat layer, may contain matte particles or the inorganic filler in an amount range similar to that of the hard coat layer.

In order to widen the difference in refractive index with the matte particles, the high refractive index layer containing high-refractive-index matte particles uses preferably silicon oxide to keep the refractive index of the layer to a low level. The preferable particle size is the same as that of the inorganic fine particles to be used for the above-described low refractive index layer.

The bulk refractive index of a mixture of a binder and the inorganic filler constituting the high refractive index layer of the invention is preferably from 1.48 to 2.00, more preferably from 1.50 to 1.80. The kind and proportion of the binder and the inorganic filler may be selected as needed so as to control the refractive index to fall within the above range. How to select the kind or proportion can be readily known empirically in advance.

The high refractive index layer is described in the paragraphs from [0197] to [0206] of Japanese Patent Laid-Open No. 2009-98658.

### [Hard Coat Layer]

The hard coat layer is provided on the surface of a support as needed in order to impart physical strength to the antireflective film. In particular, it is provided preferably between the support and the high refractive index layer (or medium refractive index layer). The hard coat layer may be functioned also as a high refractive index layer by incorporating, in the layer, the above-described high-refractive-index particles or the like.

The hard coat layer is formed preferably by the crosslinking reaction or polymerization reaction of an ionizing radiation curable resin. For example, it can be formed by applying, onto a support, a coating composition containing an ionizing radiation curable polyfunctional monomer or polyfunctional oligomer and causing a crosslinking reaction or polymerization reaction of the polyfunctional monomer or polyfunctional oligomer.

The hard coat layer, similar to the high refractive index layer, may contain matte particles or the inorganic filler in an amount range similar to that of the high refractive index layer.

The antireflective film of the invention thus formed has preferably a haze of from 3 to 70%, more preferably from 4 to 60% and an average reflectance, at from 450 nm to 650 nm, of preferably 3.0% or less, more preferably 2.5% or less. When the haze and average reflectance each falls within the above range, the antireflective film of the invention can have a good antiglare property and antireflective property without causing deterioration in a transmitted image.

### (Surface State Improver)

Coating solutions to be used for preparing any of the layers on the support may contain a surface state improver in order to alleviate troubles in the surface state (such as coating unevenness, drying unevenness, and point defect). As the surface state improver, at least any of fluorine-based and silicone-based surface state improver is preferred.

The surface state improvers are described in the paragraphs from [0258] to [0285] of Japanese Patent Laid-Open No. 2006-293329.

### [Support]

As the support of the antireflective film of the invention, a plastic film is preferred. Examples of a polymer constituting the plastic film include cellulose esters (such as triacetyl cellulose and diacetyl cellulose, typically “TAC-TD80U”, “TAC-TD80UF”, and the like, product of Fujifilm Corporation), polyamides, polycarbonates, polyesters (such as polyethylene terephthalate and polyethylene naphthalate), polystyrenes, polyolefins, norbomene resins (such as “Arton”, trade name; product of JSR Corp.), and amorphous polyolefins (such as “Zeonex”, trade name; product of Nippon Zeon Corp.). Of these, triacetyl cellulose, polyethylene terephthalate, and polyethylene naphthalate are preferred, with triacetyl cellulose being especially preferred. A cellulose acylate film substantially free from a halogenated hydrocarbon such as dichloromethane and a preparation process thereof are described in the Japan Institute of Invention and Innovation, Laid-open Technical Report (2001-1745, issued Mar. 15, 2001, hereinafter called “Laid-Open Technical Report 2001-1745”, simply), and cellulose acylates described therein are also preferred.

### [Saponification Treatment]

When the antireflective film of the invention is used for a liquid crystal display device, it is the common practice to provide it on the outermost surface of the display with an adhesive layer formed on one side of the film. When the support is made of, for example, triacetyl cellulose, triacetyl cellulose can be employed as a protective film for protecting a polarizer of a polarizing plate. It is therefore preferred from the standpoint of cost to use the antireflective film of the invention as a protective film.

When the antireflective film of the invention is located on the outermost surface of a display or used as is as a protective film for a polarizing plate as described above, it is preferred to form a low refractive index layer on the support and then conduct saponification treatment in order to improve the adhesion.

The saponification treatment is described in the paragraphs from [0289] to [0293] of Japanese Patent Laid-Open No. 2006-293329, which can be similarly applied to the invention.

### [Production Process of Antireflective Film]

The antireflection film of the invention can be produced according to the following process, but the process is not restricted thereto.

First, a coating solution containing the components for forming each layer is prepared. The resulting coating solution is applied onto on a support by using a dip coating method, an air knife coating method, a curtain coating method, a roller coating method, a wire bar coating method, a gravure coating method, an extrusion coating method, or the like (refer to U.S. Pat. No. 2,681,294), followed by heating and drying. Of these coating methods, the gravure coating method is preferably used, because a coating solution, which does not require a large coating weight, can be applied with a highly uniform film thickness as each layer of an antireflective film. Of the gravure coating methods, a micro-gravure coating method is more preferred because it can provide a more highly uniform film thickness.

Using the die coating method also makes it possible to apply a coating solution, which does not require a large coating weight, to the support with a highly uniform film thickness. Further, since the die coating method employs a pre-measure system, the control of a film thickness is comparatively easy, and evaporation of a solvent from an area to which the composition has been applied is little The die coating method is therefore preferred.

Two or more layers may be obtained by simultaneous application. Simultaneous application methods are described in U.S. Pat. Nos. 2,761,791, 2,941,898, 3,508,947, and 3,526,528, and Yuji Harasaki, Coating Kogaku (Coating Engineering), p. 253, Asakura Shoten (1973).

### [Polarizing Plate]

A polarizing plate is composed mainly of two protective films that sandwich a polarizer from both sides. The antireflective film of the invention is preferably used as at least one of these two protective films that sandwich a polarizer from both sides. When the antireflective film of the invention serves as a protective film, a manufacturing cost of the polarizing plate can be reduced. Furthermore, when the antireflective film of the invention is used as the outermost layer, it is possible to form a polarizing plate which is prevented from reflection of external light and is excellent in scar resistance and antifouling property. As the polarizer, known ones can be used. The polarizer is described in the paragraphs from [0299] to [0301] of Japanese Patent Laid-Open No. 2006-293329, which can be similarly applied to the invention.

### [Image Display Device]

The antireflective film of the invention can be used for image display devices such as a liquid crystal display device (LCD), a plasma display panel (PDP), an electroluminescence display device (ELD), a cathode ray tube display device (CRT), a field emission display (FED), and a surface-conduction electron-emitter display (SED) in order to prevent reduction in contrast due to reflection of external light or reflection of image. The antireflective film of the invention or a polarizing plate having the antireflective film is preferably located on the surface (on the viewing side on the display screen) of the display of the liquid crystal display device.

When the antireflective film of the invention is used as one side of a surface protective film of a polarizer, it can be preferably used for transmission type, reflection type or semi-transmission type liquid crystal display devices of a twisted nematic (TN) mode, a super twisted nematic (STN) mode, a vertical alignment (VA) mode, an in-plane switching (IPS) mode, an optically compensated bend cell (OCB) mode, an electrically controlled birefringence (ECB) mode or the like. The liquid crystal display device is described in the paragraphs from [0303] to [0307] of Japanese Patent Laid-Open No. 2006-293329.

### Examples

The invention will hereinafter be described by Examples, but the invention is not limited to them. Unless otherwise specifically indicated, “part” or “parts” and “%” are on a mass basis.

### [Preparation of Coating Solutions for Hard Coat Layer (HC-1, HC-2)]

A coating solution for hard coat layer was prepared by adding the components in accordance with the composition shown in Table 3 and filtering the resulting mixture through a polypropylene filter having a pore size of 30 μm.

TABLE 3

| | Coating solution HC-1 | Coating solution HC-2 |
|---|---|---|
| Binder | “PET-30”: 22.9 parts by mass | “DPCA-20”: 40.5 parts by mass |
| | “Viscoat 360”: 22.9 parts by mass | — |
| Polymerization initiator | “Irgacure 127”: 1.5 parts by mass | “Irgacure 184”: 2.7 parts by mass |
| Light diffusive particles | 8 μm Crosslinking acryl styrene particles | — |
| | 30% MiBK dispersion: 8.3 parts by mass | |
| Solvent | MiBK: 19.2 parts by mass | MEK: 48.6 parts by mass |
| | MEK: 25 parts by mass | Cyclohexanone: 5.4 parts by mass |
| The other component | — | Silica sol: 2.7 parts by mass |
| Leveling agent | FP-13/0.1 part by mass | “FP-13”: 0.1 part by mass |

The following are compounds in the above table.
“PET-30”: mixture of pentaerythritol triacrylate and pentaerythritol tetraacrylate [product of Nippon Kayaku]
“Viscoat 360”: trimethylolpropane PO-modified triacrylate [product of Osaka Organic Chemical Industry]
“DPCA-20”: partially caprolactone-modified polyfunctional acrylate [product of Nippon Kayaku]
Silica sol: “MiBK-ST” [product of Nissan Chemical Industries]
8 μm Cross-linked acryl·styrene particles (30 mass %): MiBK dispersion obtained by dispersing particles having an average particle size of 8.0 μm [product of Sekisui Chemical] at 10000 rpm for 20 minutes by using a Polytron homogenizer
“Irgacure 127”: polymerization initiator [product of Ciba Specialty Chemicals]
“Irgacure 184”: polymerization initiator [product of Ciba Specialty Chemicals]
“FP-13”: fluorine-based surface modifier described in [0341] of Japanese Patent Laid-Open No. 2009-063983 (used as a 10 mass % MEK solution after dissolution)

### [Preparation of Low-Refractive-Index Layer Coating Solutions (Ln-1 to 24)]

A low-refractive-index layer coating solution having a solid content of 2.5 mass % was prepared by mixing the components in accordance with the composition shown in Table 4. The numerical values in the table are solid contents which are nonvolatile contents given in terms of parts by mass.

The coating solutions Ln-2 to Ln-24 showed good solubility, while Ln-1 was not suited for coating due to insufficient solubility.

The conductive compounds (A) to (F) in Table 4 indicate the respective conductive polymers and polymer dopants in the conductive polymer compositions (A) to (F) prepared in the following manner.

### Preparation Example 1

### Preparation of a Conductive Polymer Composition (A) (Aqueous Solution)

To 1000 ml of a 2 mass % aqueous solution of polystyrene sulfonic acid (PSS, having a molecular weight of about 100000) (“PS-5”, trade name; product of Tosoh Organic Chemicals) was added 8.0 g of 3,4-ethylenedioxythiophene (EDOT) and they were mixed at 20° C. After addition of 100 ml of an oxidation catalyst solution (containing 15 mass % of ammonium persulfate and 4.0 mass % of ferric sulfate), the resulting mixture was reacted by stirring at 20° C. for 3 hours.

To the reaction mixture thus obtained was added 1000 ml of ion exchanged water and about 1000 ml of the solution was removed by using ultrafiltration. This operation was repeated three times.

To the solution thus obtained, 100 ml of an aqueous sulfuric acid solution (10 mass %) and 1000 ml of ion exchanged water were added and about 1000 ml of the solution was removed by using ultrafiltration. To the resulting solution was added 1000 ml of ion exchanged water and then, ultrafiltration was used to remove about 1000 ml of the solution. This operation was repeated five times. As a result, an aqueous solution containing about 1.1 mass % of polyethylene dioxythiophene (PEDOT) and PSS was obtained. The solid content concentration of the resulting aqueous solution was adjusted to 1.0 mass % (at 20° C.) with ion exchanged water to obtain a conductive polymer composition (A). The resulting conductive polymer composition (A) is an aqueous solution and the relative permittivity of water is 80.

### Preparation Example 2

### Preparation of Conductive Polymer Composition (B) (Water/Acetone Solution)

After addition of 200 ml of acetone to 200 ml of the conductive polymer composition (A) prepared in Preparation Example 1, 210 ml of water and acetone were removed by ultrafiltration. This operation was repeated once. The solid content concentration was adjusted with acetone and a conductive polymer composition (B) was obtained as a 1.0 mass % (at 20° C.) water/acetone solution. The resulting solution had a water content of 15 mass % and the relative permittivity of the solvent was 30.3.

### Preparation Example 3

### Preparation of Conductive Polymer Composition (C) (Acetone Solution)

After addition of 500 ml of acetone having 2.0 g of trioctylamine dissolved therein to 200 ml of the conductive polymer composition (B) prepared in Preparation Example 2, the resulting mixture was stirred for 3 hours with a stirrer. Ultrafiltration was performed to remove 510 ml of water and acetone. The solid content concentration was adjusted with acetone and a conductive polymer composition (C) was obtained as a 1.0 mass % (at 20° C.) acetone solution. The resulting solution had a water content of 2 mass % and the relative permittivity of the solvent was 22.7.

### Preparation Example 4

### Preparation of Conductive Polymer Composition (D) (Methyl Ethyl Ketone Solution)

To 200 ml of the conductive polymer composition (C) prepared in Preparation Example 3 was added 300 ml of methyl ethyl ketone (MEK) and they were mixed. The resulting mixture was concentrated under reduced pressure at room temperature to give a total amount of 200 ml. The solid content was adjusted with methyl ethyl ketone to obtain the conductive polymer composition (D) as a 1.0 mass % (at 20° C.) methyl ethyl ketone solution. The resulting solution had a water content of 0.05 mass % and the remaining ratio of acetone was 1 mass % or less. The relative permittivity of the solvent was 15.5.

### Preparation Example 5

### Preparation of Conductive Polymer Composition (E) (Synthesis of Aniline Polymerization Product)

Aniline (10 parts) was added dropwise to 100 parts of a 1.2 mol/litre aqueous hydrochloric acid solution under stirring and the reaction mixture was cooled to 10° C. An aqueous solution obtained in advance by dissolving 28 parts of ammonium persulfate in 28 parts of ion exchanged water was added dropwise to the reaction mixture over 4 hours. After completion of the dropwise addition, the reaction mixture was stirred further at 10° C. for 4 hours. A green precipitate thus formed was filtered and washed with ion exchanged water until the color of the filtrate disappeared. The precipitates were collected and dispersed in an aqueous ammonia solution. The resulting dispersion was filtered at 25° C. for 2 hours. The filtrate was washed with ion exchanged water until the color of the filtrate disappeared and then dried to obtain a polymerization product of aniline.

### (Preparation of Polyanion Dopant)

A monomer mixture was prepared by dissolving 25 parts (20 mol % based on all the monomer components) of 2-acrylamido-methylpropane sulfonic acid, 15 parts (15 mol % based on all the monomer components) of a (methoxypolyethylene glycol methyl methacrylate) macromonomer having a mono-terminal methacryloyl group (“NK ester M-230G”, trade name; product of Shin-Nakamura Chemical), 65 parts (65 mol % based on all the monomer components) of styrene, and 3 parts of azoisobutyronitrile as a polymerization initiator in a mixed aqueous solution, as a solvent, of 20 parts by ion exchanged water and 130 parts of ethyl alcohol. Thus, a polyanion dopant solution was prepared. Next, in a separable flask equipped with an agitating blade, an inert gas inlet tube, a reflux condenser, a thermometer, and a dropping funnel, the monomer mixture prepared above was charged and polymerization reaction was performed at 75° C. for 4 hours. Then, 1 part of azoisobutyronitrile was added to the reaction mixture. After polymerization aging at 75° C. for 4 hours, the reaction mixture was cooled to 30° C. to obtain a sulfonic-acid-containing polyanion dopant solution having a nonvolatile content of 40%.

(Doping of Polyanion Dopant into Polymerization Product of Aniline)

Then, 5 parts of the polymerization product of aniline, 125 parts of the polyanion dopant solution, and 370 parts of water were charged to mix them well. The resulting mixture was dispersed for 1 hour at a circumferential speed of 10 m/sec and a discharge rate of 0.5 litre/min by using zirconia beads (0.5 mm diameter) in a distribution type sand grinder mill “UVM-2” (trade name; product of AIMEX K.K.). The temperature upon dispersing was adjusted to be 75° C. In such a manner, an aniline polymer composition having a concentration of 11% was obtained.

### (Substitution of Solvent)

After addition of 200 ml of ethyl alcohol to 20 ml of the aniline polymer composition, 100 ml of water and ethyl alcohol were removed by ultrafiltration. To 120 ml of the remaining portion of the composition, 200 ml of ethyl alcohol was added and 100 ml of water and ethyl alcohol was removed by ultrafiltration. This operation was repeated twice and the solid content concentration was controlled with ethyl alcohol to prepare an organic conductive polymer solution (E) as a 1.0 mass % (at 20° C.) water/ethyl alcohol solution. The resulting solution had a water content of 1 mass % and the relative permittivity of the mixed solvent was 26.2.

### Preparation Example 6

### Preparation of Conductive Polymer Solution (F)

In accordance with Example 4 of European Patent No. 328981, a conductive polymer for comparison was prepared by electrochemically polymerizing 3-dodecyloxythiophene in acetonitrile in the presence of tetraethylammonium tetrafluoroborate and thereby incorporating the monoanion dopant in the polythiophene derivative. The resulting polythiophene derivative was dissolved in a 9:1 (mass ratio) mixed solution of tetrahydrofuran and butyl acetate to give a 1 mass % (at 20° C.) solution to prepare an organic conductive polymer solution (F). The relative permittivity of the mixed solvent was 7.25.

TABLE 4

| | Content (solid content) | | | | | | | | |
|---|---|---|---|---|---|---|---|---|---|
| | Fluorine- | | | | | | | | Polymerization |
| | containing | | Conductive | | | | Antifouling | | initiator |
| | copolymer | | compound | | Polyfunctional polymer | | agent | | (Irgacure 127) |
| | Kind | Amount | Kind | Amount | Kind | Amount | Kind | Amount | Amount |
| Ln-1 | P-13 | 77 | (A) | 20 | — | — | — | — | 3 |
| Ln-2 | P-13 | 77 | (B) | 20 | — | — | — | — | 3 |
| Ln-3 | — | — | (B) | 20 | DPHA | 77 | — | — | 3 |
| Ln-4 | — | — | (D) | 20 | DPHA | 77 | — | — | 3 |
| Ln-5 | — | — | (D) | 77 | DPHA | 20 | — | — | 3 |
| Ln-6 | P-13 | 57 | (ATO-1) | 40 | — | — | — | — | 3 |
| Ln-7 | P-13 | 77 | (F) | 20 | — | — | — | — | 3 |
| Ln-8 | — | — | — | — | Tetraethoxysilane | 92 | — | — | — |
| | | | | | Perfluorooctylethyl | 5 | | | |
| | | | | | triethoxysilane | | | | |
| Ln-9 | — | — | (D) | 20 | Tetraethoxysilane | 72 | — | — | — |
| | | | | | Perfluorooctylethyl | 5 | | | |
| | | | | | triethoxysilane | | | | |
| Ln-10 | P-13 | 77 | (D) | 20 | — | — | — | — | 3 |
| Ln-11 | P-13 | 77 | (C) | 20 | — | — | — | — | 3 |
| Ln-12 | P-14 | 77 | (D) | 20 | — | — | — | — | 3 |
| Ln-13 | P-15 | 77 | (D) | 20 | — | — | — | — | 3 |
| Ln-14 | P-16 | 77 | (D) | 20 | — | — | — | — | 3 |
| Ln-15 | P-15 | 70 | (D) | 20 | DPHA | 7 | — | — | 3 |
| Ln-16 | P-15 | 30 | (D) | 20 | DPHA | 7 | — | — | 3 |
| Ln-17 | P-15 | 30 | (D) | 20 | DPHA | 7 | — | — | 3 |
| Ln-18 | P-15 | 25 | (D) | 20 | DPHA | 7 | MF1 | 5 | 3 |
| Ln-19 | P-15 | 47 | (D) | 3 | DPHA | 7 | MF1 | 5 | 3 |
| Ln-20 | P-15 | 20 | (D) | 45 | DPHA | 7 | MF1 | 5 | 3 |
| Ln-21 | P-15 | 25 | (E) | 20 | DPHA | 7 | MF1 | 5 | 3 |
| Ln-22 | P-4 | 27 | (D) | 20 | DPHA | 6 | MF1 | 5 | — |
| Ln-23 | P-1 | 27 | (D) | 20 | DPHA | 6 | MF1 | 5 | — |
| Ln-24 | P-15 | 25 | (D) | 20 | DPHA | 7 | MF1 | 5 | 3 |

| | Content (solid content) | | | | | |
|---|---|---|---|---|---|---|
| | Dispersion | | Others | | | |
| | Kind | Amount | Kind | Amount | Diluting solvent | Remarks |
| Ln-1 | — | — | — | — | MEK (80 wt %)/PGMEA (20 wt %) | Comp. Ex. |
| Ln-2 | — | — | — | — | MEK (80 wt %)/PGMEA (20 wt %) | Comp. Ex. |
| Ln-3 | — | — | — | — | MEK (80 wt %)/PGMEA (20 wt %) | Comp. Ex. |
| Ln-4 | — | — | — | — | MEK (80 wt %)/PGMEA (20 wt %) | Comp. Ex. |
| Ln-5 | — | — | — | — | MEK (80 wt %)/PGMEA (20 wt %) | Comp. Ex. |
| Ln-6 | — | — | — | — | MEK (80 wt %)/PGMEA (20 wt %) | Comp. Ex. |
| Ln-7 | — | — | — | — | MEK (80 wt %)/PGMEA (20 wt %) | Comp. Ex. |
| Ln-8 | — | — | HNO₃ (acid | 3 | IPA | Comp. Ex. |
| | | | catalyst) | | | |
| Ln-9 | — | — | HNO₃ (acid | 3 | IPA | Comp. Ex. |
| | | | catalyst)- | | | |
| Ln-10 | — | — | — | — | MEK (80 wt %)/PGMEA (20 wt %) | Ex. |
| Ln-11 | — | — | — | — | MEK (80 wt %)/PGMEA (20 wt %) | Ex. |
| Ln-12 | — | — | — | — | MEK (80 wt %)/PGMEA (20 wt %) | Ex. |
| Ln-13 | — | — | — | — | MEK (80 wt %)/PGMEA (20 wt %) | Ex. |
| Ln-14 | — | — | — | — | MEK (80 wt %)/PGMEA (20 wt %) | Ex. |
| Ln-15 | — | — | — | — | MEK (80 wt %)/PGMEA (20 wt %) | Ex. |
| Ln-16 | A-1 | 40 | — | — | MEK (80 wt %)/PGMEA (20 wt %) | Ex. |
| Ln-17 | A-2 | 40 | — | — | MEK (80 wt %)/PGMEA (20 wt %) | Ex. |
| Ln-18 | A-2 | 40 | — | — | MEK (80 wt %)/PGMEA (20 wt %) | Ex. |
| Ln-19 | A-2 | 40 | — | — | MEK (80 wt %)/PGMEA (20 wt %) | Ex. |
| Ln-20 | A-2 | 20 | — | — | MEK (80 wt %)/PGMEA (20 wt %) | Ex. |
| Ln-21 | A-2 | 40 | — | — | MEK (80 wt %)/PGMEA (20 wt %) | Ex. |
| Ln-22 | A-2 | 40 | CYMEL | 2/0.1 | MEK (80 wt %)/PGMEA (20 wt %) | Ex. |
| | | | 303/catalyst | | | |
| | | | 4050 | | | |
| Ln-23 | A-2 | 40 | CYMEL | 2/0.1 | MEK (80 wt %)/PGMEA (20 wt %) | Ex. |
| | | | 303/catalyst | | | |
| | | | 4050 | | | |
| Ln-24 | A-2 | 40 | — | — | MEK (80 wt %)/PGMEA (20 wt %) | Ex. |

The following are compounds shown in the above table.
DPHA: mixture of dipentaerythritol pentaacrylate and dipentaerythritol hexaacrylate (product of Nippon Kayaku)
“Irgacure 127”; photopolymerization initiator [product of Ciba Specialty Chemicals]
MF1: Compound a-1 exemplified in the section of “(E) fluorine-containing antifouling agent”
A-1: silica fine-particle dispersion A-1 prepared in the process described below (solid content: 22 mass %)
A-2: hollow silica fine-particle dispersion A-2 prepared in the process described below (solid content: 22 mass %)
“CYMEL 303”: methylal melamine resin (product of Mitsui Cytec)
“Catalyst 4050”: paratoluenesulfonic acid-triethylamine salt (product of Nihon Cytec Industries)
ATO-1: A commercially available coating for transparent antistatic layer “Peltron C-4456S-7” {solid content concentration: 45 mass %, product of Nippon Pelnox} was used as a coating solution for antistatic layer (ATO-1). “Peltron C4456S-7” is a coating for transparent antistatic layer containing conductive fine particles ATO dispersed using a dispersing agent. The coated film obtained using this coating had a refractive index of 1.55. The amount shown in Table 4 indicate the solid amount of ATO-1 in the low-refractive-index layer coating solution.
Tetraethoxysilane: product of Shin-Etsu Chemical
Perfluorooctylethyl triethoxysilane: product of Dow Corning Toray
MEK: 2-butanone (boiling point: 79.6° C.)
PGMEA: propylene glycol monomethyl ether acetate (boiling point: 146° C.)
MiBK: 2-methyl-4-pentanone (boiling point: 115.9° C.)
IPA: i-propyl alcohol (boiling point: 82° C.)

### (Preparation of Silica Fine-Particle Dispersion A-1)

A silica fine-particle dispersion A-1 was prepared by diluting commercially available silica fine-particle dispersion (“IPA-ST-L”, product of Nissan Chemical, solid content concentration of silica: 30 mass %, solvent: isopropyl alcohol) having an average particle size of 50 nm with isopropyl alcohol to give a solid content concentration of silica of 22 mass %.

### (Preparation of Hollow Silica Fine-Particle Dispersion A-2)

After adding, to 500 g of hollow silica fine-particle sol (isopropyl alcohol sol, average particle size: 60 nm, shell thickness: 10 nm, silica concentration: 20 mass %, refractive index of silica particles: 1.31, prepared in a similar manner to Preparation Example 4 of Japanese Patent Laid-Open No. 2002-79616 except for the change of the size), 10 g of acryloyloxypropyl trimethoxysilane (product of Shin-Etsu Chemical) and 1.0 g of diisopropoxy aluminum ethyl acetate and mixing them, 3 g of ion exchanged water was added. The resulting mixture was reacted at 60° C. for 8 hours. After cooling to room temperature, 1.0 g of acetyl acetone was added to the reaction mixture. Solvent substitution was performed by using vacuum distillation while adding cyclohexanone to 500 g of the dispersion so that the content of silica became substantially constant. No foreign matter appeared in the dispersion and the viscosity when the solid content concentration was adjusted to 22 mass % with cyclohexanone was 5 mP·s at 25° C. A remaining amount of isopropyl alcohol in the hollow silica fine-particle dispersion A-2 thus obtained was analyzed by using gas chromatography, resulting in 1.0 mass %.

### [Preparation of Antireflective Film]

### (Formation of Hard Coat Layer)

A hard coat layer was formed by applying a coating solution (HC-1 or HC-2) for hard coat layer onto a triacetyl cellulose film “TAC-TD80U” (product of FUJIFILM CORPORATION) having a thickness of 80 μm and a width of 1340 mm at a line speed of 30 m/min by using a micro gravure coating system, drying at 60° C. for 150 seconds, and exposing the coated layer to ultraviolet rays having an illuminance of 400 mW/cm² and an exposure dose of 150 mJ/cm² with an air cooling metal halide lamp of 160 W/cm (product of EYEGRAPHICS) under nitrogen purge (oxygen concentration: 0.5% or less) to cure the layer.

### (Formation of Low Refractive Index Layer)

A low refractive index layer was formed by applying the low-refractive-index layer coating solution (any of Ln-1 to Ln-23) onto the resulting hard coat layer by using a micro gravure coating system while adjust the thickness of the low refractive index layer to a desired one and curing the coated layer under the curing conditions described below. Thus, an antireflective film was prepared.

Further, a low refractive index layer was formed by applying the low-refrative-index layer coating solution Ln-24 directly onto the triacetyl cellulose film without a hard coat layer by using a micro gravure coating system while adjust the thickness of the low refractive index layer to a desired one and curing the coated layer under the curing condition described below. Thus, an antireflective film was prepared.

The following are curing conditions employed for the formation of a low refractive index layer.

### <Curing Conditions for Ln-1 to Ln-7, Ln-10 to Ln-21, and Ln-24>

(1) Drying: at 80° C. for 120 seconds
(2) Heat treatment before exposure: at 95° C. for 5 minutes
(3) UV curing: UV curing was performed at 90° C. for one minute by using an air-cooling metal halide lamp of 240 W/cm (product of EYEGRAPHICS) at an illuminance of 120 mW/cm² and an exposure dose of 240 mJ/cm² while nitrogen purging to give an oxygen concentration of 0.01% by volume or less.
(4) Heat treatment after exposure: at 30° C. for 5 minutes

### <Curing Conditions for Ln-8, Ln-9, Ln-22, and Ln-23>

Drying, heat treatment: at 100° C. for 120 seconds

### [Saponification Treatment of Antireflective Film]

The antireflective film samples thus obtained were subjected to the following saponification treatment.

A 1.5 mol/L aqueous solution of sodium hydroxide was prepared and it was kept at 55° C. A 0.005 mol/L aqueous solution of dilute sulfuric acid was prepared and it was kept at 35° C. The antireflective film prepared above was dipped for 2 minutes in the aqueous solution of sodium hydroxide and then, was dipped in water to rinse away the aqueous solution of sodium hydroxide sufficiently. The resulting sample was then dipped in the aqueous solution of dilute sulfuric acid for one minute and was dipped in water to rinse away the aqueous solution of dilute sulfuric acid sufficiently. Finally, the sample was dried sufficiently at 120° C. In such a manner, a saponified antireflective film was prepared.

Combinations of the hard coat layer (HC layer) and the low refractive index layer (Ln layer) in the antireflective film, and refractive indices of the respective layers are shown in Table 5. The refractive indices of the respective layers were measured by an Abbe refractometer. Here, the refractive index of the HC layer formed by the coating solution HC-1 is a refractive index of the cured matrix (i.e, a refractive index of the layer where the light diffusive particles were excluded). The refractive indices of the Ln layers in Comparative Examples 6 to 7 were higher than 1.50 (the layer was referred to as low refractive layer, but it substantially was not a low refractive index layer) and their antireflective properties were not sufficient.

TABLE 5

| | HC layer | | | Ln layer | | |
|---|---|---|---|---|---|---|
| | Coating | | Refractive | Coating | Film | Refractive |
| | solution | Film thickness | index | solution | thickness | index |
| Comp. Ex. 1 | HC-1 | 13 μm | 1.52 | Ln-1 | 95 nm | — |
| Comp. Ex. 2 | HC-1 | 13 μm | 1.52 | Ln-2 | 110 nm | 1.5 |
| Comp. Ex. 3 | HC-1 | 13 μm | 1.52 | Ln-3 | 95 nm | 1.51 |
| Comp. Ex. 4 | HC-1 | 13 μm | 1.52 | Ln-4 | 95 nm | 1.51 |
| Comp. Ex. 5 | HC-1 | 13 μm | 1.52 | Ln-5 | 95 nm | 1.51 |
| Comp. Ex. 6 | HC-1 | 13 μm | 1.52 | Ln-6 | 95 nm | 1.51 |
| Comp. Ex. 7 | HC-1 | 13 μm | 1.52 | Ln-7 | 95 nm | 1.49 |
| Comp. Ex. 8 | HC-1 | 13 μm | 1.52 | Ln-8 | 95 nm | 1.44 |
| Comp. Ex. 9 | HC-1 | 13 μm | 1.52 | Ln-9 | 95 nm | 1.49 |
| Ex. 1 | HC-1 | 13 μm | 1.52 | Ln-10 | 110 nm | 1.47 |
| Ex. 2 | HC-1 | 13 μm | 1.52 | Ln-11 | 110 nm | 1.47 |
| Ex. 3 | HC-1 | 13 μm | 1.52 | Ln-12 | 110 nm | 1.46 |
| Ex. 4 | HC-1 | 13 μm | 1.52 | Ln-13 | 110 nm | 1.46 |
| Ex. 5 | HC-1 | 13 μm | 1.52 | Ln-14 | 110 nm | 1.46 |
| Ex. 6 | HC-1 | 13 μm | 1.52 | Ln-15 | 110 nm | 1.46 |
| Ex. 7 | HC-1 | 13 μm | 1.52 | Ln-16 | 110 nm | 1.46 |
| Ex. 8 | HC-1 | 13 μm | 1.52 | Ln-17 | 110 nm | 1.41 |
| Ex. 9 | HC-1 | 13 μm | 1.52 | Ln-18 | 110 nm | 1.41 |
| Ex. 10 | HC-1 | 13 μm | 1.52 | Ln-19 | 95 nm | 1.41 |
| Ex. 11 | HC-1 | 13 μm | 1.52 | Ln-20 | 140 nm | 1.48 |
| Ex. 12 | HC-1 | 13 μm | 1.52 | Ln-21 | 110 nm | 1.41 |
| Ex. 13 | HC-1 | 13 μm | 1.52 | Ln-22 | 110 nm | 1.43 |
| Ex. 14 | HC-1 | 13 μm | 1.52 | Ln-23 | 110 nm | 1.44 |
| Ex. 15 | HC-2 | 6 μm | 1.52 | Ln-17 | 110 nm | 1.41 |
| Ex. 16 | HC-2 | 6 μm | 1.52 | Ln-18 | 110 nm | 1.41 |
| Ex. 17 | — | — | — | Ln-24 | 110 nm | 1.4 |

### [Evaluation of Antireflective Film]

The films thus obtained were evaluated and measured for the following items.

### (Evaluation 1) Measurement of Average Integrated Reflectance

After the film was laminated with a polarizing plate with Crossed nicols, a spectral reflectance (%) at an incident angle of 5° was measured in a wavelength region from 380 to 780 nm by using a spectrophotometer (product of JASCO Corporation). An integrating sphere average reflectance (%) at from 450 to 650 nm was used as the result. When the functional layers have the same refractive index and same film thickness, poor affinity on the interface between these functional layers may cause microscopic unevenness, resulting in an increase in integrated reflectance.

### (Evaluation 2) Evaluation of Antifouling Property by Using a Magic Marker Stain Wiping Test

The film was fixed onto a glass surface via a adhesive, and a circle of 5 mm in diameter was written thereon in three turns with a pen tip (fine) of a black magic marker, “Macky Gokuboso” (trade name, manufactured by ZEBRA Co.), under the conditions of 25° C. and 60% RH, and after 5 seconds, wiped off with a 10-ply folded and bundled unwoven cloth (“Bencot” trade name, manufactured by Asahi Kasei Corp.) by moving the bundle back and forth 20 times under a load large enough to make a dent in the Bencot bundle. The writing and wiping were repeated under the above-described conditions until the magic marker stain could not be eliminated by the wiping, and thus the antifouling property could be evaluated by the number of repetitions taken to wipe off the magic marker stain. The number of repetitions taken to wipe off the magic marker stain was evaluated with 50 as an upper limit. The number of repetitions until the marker stain cannot be eliminated is preferably 5 or more, more preferably 10 or more, most preferably 50 or more.

### (Evaluation 3) Evaluation of Scratch Resistance

By using a rubbing tester, a rubbing test was conducted under the following conditions.
Environmental conditions for evaluation: at 25° C. and 60% RH
Rubbing material: Steel wool (Grade No. 0000, product of Nippon Steel Wool Co., Ltd.) was wound around and band-fixed at a rubbing tip (1 cm×1 cm) of a tester to be brought into contact with the sample. A reciprocal rubbing movement was given to the sample under the following conditions.
Shifting distance (one way): 13 cm, rubbing speed: 13 cm/sec,
Load: 500 g/cm², contact area at the tip: 1 cm×1 cm
Number of rubbing: 10 reciprocations

An oily black ink was applied onto the back side of the sample after the rubbing. After visual observation with reflection light, the scratch at the rubbed portion was evaluated based on the following criteria.
A: No scratch is found even when observed extremely carefully.
B: Weak scratches are faintly found when observed extremely carefully.
C: Weak scratches are found.
D: Scratches of medium degree are found.
E: Scratches are found at a glance.

### (Evaluation 4) Evaluation of Adhesion

A sample of the antireflective film was subjected to humidity conditioning for 2 hours at 25° C. and 60% RH. The surface of each sample on the side having the low refractive index layer thereon was cross-cut with a cutter knife to give 11 vertical cuts and 11 horizontal cuts, thereby forming 100 square cross-cuts in total. A polyester adhesive tape (No. 31B) made by Nitto Denko Corporation was attached to the surface. Thirty minutes later, the tape was peeled off speedily in a perpendicular direction. The number of the squares peeled off was counted and the adhesion was evaluated based on the following four ranks. The same adhesion evaluation was performed three times and an average was taken.
A: No peeling was recognized in 100 squares
B: Peeling was recognized in 1 or 2 squares of the 100 squares.
C: Peeling was recognized in 3 to 10 squares of the 100 squares (allowable range)
D: Peeling was recognized in 11 or more squares of the 100 squares.

### (Evaluation 5) Measurement of Surface Resistivity

The surface resistivity of the surface of an antireflective film on the side having a low refractive index layer (outermost layer) was measured with a super insulation resistance/micro-ammeter “TR8601” (trade name; product of Advantest Corporation) at 25° C. and 60% RH. The common logarithm (Log SR) of the surface resistivity SR (Ω/sq) was shown in Table 6 as a surface resistivity.

### (Evaluation 6) Evaluation of Dust Resistance

The transparent support side of the antireflective film sample was attached to the surface of CRT and the resulting CRT was used for 24 hours in a room containing dust and tissue paper dust particles having a size of 0.5 μm or greater in an amount of from 100 to 2000000 per ft³ (cubic feet). Then, the numbers of dust and tissue paper dust particles per 100 cm² of the antireflective film were counted and average number was evaluated based on the following criteria.
A: Less than 20
B: From 20 to 49
C: From 50 to 199
D: 200 or more

### (Evaluation 7) Evaluation of Surface State Observed Visually Through Optical Inspection

The evenness of the surface state (free from wind-induced unevenness, drying unevenness, and unevenness due to coating streak) of the film was totally evaluated in detail by (1) inspection of a permeable surface under a three band fluorescent lamp and (2) by inspection, under a three band fluorescent lamp, of a reflecting surface obtained by applying an oily black ink on a side contrary to the functional-layer coated surface.
1. Bad surface state
2. Not desired surface state
3. Needs some improvement
4. Good
5. Excellent

### (Evaluation 8) Measurement of Uneven Distribution of Organic Conductive Material

After obliquely cutting the antireflective film at an angle of 0.05° by using a microtome, the cut surface of the coated film was analyzed by using the TOF-SIMS method and distribution of the conductive polymer in the film thickness direction was measured.

Then, the lower-part uneven distribution was calculated according to the following formula:

Lower-part uneven distribution=[mass of conductive polymer present in a lower 50% region, from the center, in film thickness direction of low refractive index layer]÷[total mass of conductive polymer present in the entirety of low refractive index layer]×100 (%)

Measurement by using the TOF-SIMS method was performed under the following conditions:
Apparatus: “TRIFTII” (trade name; product of Physical Electronics (PHI))
Primary ion: Ga⁺ (15 kV)
Aperture: No. 3 (Ga⁺ current value: corresponding to 600 pA)
The number of mapping points: 256×256
Mass of secondary ion to be detected: from 0 to 1000 amu (amu: atom mass unit)
Integration time: 60 minutes

The above-described results are shown in the following table.

TABLE 6

| | Integrated | | | | | | |
|---|---|---|---|---|---|---|---|
| | reflectance | Wiping ease of | Scratch | | Surface | Dust | Optical surface |
| | (%) | Magic pen | resistance | Adhesion | resistivity | resistance | property |
| Comp. Ex. 1 | — | — | — | — | — | — | — |
| Comp. Ex. 2 | 3.8 | 2 | E | B | 15 | D | 1 |
| Comp. Ex. 3 | 4.5 | 0 | E | B | 14 | D | 2 |
| Comp. Ex. 4 | 4.5 | 0 | A | B | 12 | C | 3 |
| Comp. Ex. 5 | 4.5 | 0 | E | D | 10 | D | 1 |
| Comp. Ex. 6 | 4.5 | 0 | A | B | 11 | B | 2 |
| Comp. Ex. 7 | 3.5 | 2 | E | B | 12 | C | 2 |
| Comp. Ex. 8 | 2.3 | 2 | A | B | 14.5 | D | 4 |
| Comp. Ex. 9 | 3.6 | 2 | A | B | 13.5 | D | 3 |
| Ex. 1 | 3.2 | 2 | B | A | 11 | B | 4 |
| Ex. 2 | 3.2 | 2 | B | A | 10.5 | B | 4 |
| Ex. 3 | 3.0 | 5 | B | A | 9 | B | 4 |
| Ex. 4 | 3.0 | 5 | B | A | 9 | B | 4 |
| Ex. 5 | 3.0 | 5 | B | A | 9 | B | 4 |
| Ex. 6 | 3.0 | 8 | A | A | 8.5 | A | 5 |
| Ex. 7 | 3.1 | 8 | A | A | 8 | A | 5 |
| Ex. 8 | 1.9 | 8 | A | A | 8 | A | 5 |
| Ex. 9 | 1.9 | 8 | A | A | 6 | A | 5 |
| Ex. 10 | 1.9 | 8 | A | A | 11 | B | 5 |
| Ex. 11 | 3.5 | 3 | B | B | 6 | A | 4 |
| Ex. 12 | 1.9 | 8 | A | A | 7 | A | 5 |
| Ex. 13 | 2.3 | 8 | B | A | 9 | B | 5 |
| Ex. 14 | 2.5 | 8 | B | A | 11 | B | 4 |
| Ex. 15 | 1.9 | 8 | A | A | 8 | A | 5 |
| Ex. 16 | 1.9 | 8 | A | A | 6 | A | 5 |
| Ex. 17 | 1.9 | 8 | A | B | 7 | A | 4 |

The uneven distribution of the organic conductive material in the film thickness direction of the low refractive index layer of the antireflective film obtained in Example 1 and the antireflective film obtained in Example 9 was evaluated by using the method of Evaluation 8. The uneven distribution of the film of Example 1 was 57% and that of the film of Example 9 was 83%. The uneven distribution of the organic conductive material in the antireflective film of Example 9 is high, meaning that the surface resistivity is low. As a result, it has been found that the film has excellent dust resistance.

### [Evaluation in Liquid Crystal Display Device]

### (Preparation of Polarizing Plate)

A polarizing plate was prepared by adhering, as a protective film, a triacetyl cellulose film (“TAC-TD80U”, trade name; product of FUJIFILM) of 80 μm thick which had been immersed in a 1.5 mol/L aqueous NaOH solution of 55° C. for 2 minutes, neutralized, and washed with water and each of the antireflective films (after saponification) obtained in Examples and Comparative Examples to both sides of a polarizer prepared by adsorbing iodine to a polyvinyl alcohol film and stretching the resulting film.

### (Manufacture of Liquid Crystal Display Device)

A liquid crystal display device having each of the antireflective films obtained in Examples and Comparative Examples was manufactured by peeling a polarizing plate from a VA-mode liquid crystal display device (“LC-37GS10”, trade name; product of Sharp Corporation) and instead, laminating the polarizing plate obtained above so that their transmission axes corresponded to each other. Incidentally, the polarizing plate was laminated so as to bring the antireflective film on the viewing side.

The polarizing plate and image display device thus manufactured using any of the antireflective films obtained in Examples have excellent conductivity even after saponification treatment of the polarizing plate and they are excellent in surface state without streaks or unevenness and have excellent scratch resistance, antifouling property, dust resistance, and adhesion similar to the antireflective films laminated to the polarizing plate or image display device. On the other hand, after saponification treatment of the polarizing plate, the common logarithm (Log SR) of the surface resistivity SR (Ω/sq) of the antireflective film obtained in Comparative Example 7 decreased even to 14, suggesting that the dust resistance is not adequate. It is presumed that the decrease in conductivity occurred because the monomer dopant was eluted by the saponification treatment. The liquid display device using each of the antireflective films obtained in Examples shows a very high display quality without reflection of the background and is excellent in antifouling property.

1. An antireflective film comprising:
a support; and
a low refractive index layer formed from a composition for low refractive index layer, the composition including the components (A) and (B):
(A) a fluorine-containing polymer having a crosslinking group, and
(B) a conductive polymer composition including a π-conjugated conductive polymer and a polymer dopant having an anion group, the conductive polymer composition being hydrophobized,
wherein the antireflective film has a Log SR of 13 or less, Log SR being a common logarithm of a surface resistivity SR (Ω/sq) of a surface on a side having the low refractive index layer with respect to the support.

2. The antireflective film according to claim 1, wherein the π-conjugated conductive polymer is one selected from the group consisting of polythiophene, polyaniline, polythiophene derivatives, and polyaniline derivatives.

3. The antireflective film according to claim 1, wherein the fluorine-containing polymer (A) is a copolymer represented by formula (1):
(MF1)ₐ-(MF2)_{b}-(MF3)_{c}-(MA)_{d}-(MB)ₑ
wherein a to e represent molar fractions of respective constituents and satisfy: 0≦a≦70, 0≦b≦70, 30≦a+b≦70, 0≦c≦50, 5≦d≦50, and 0≦e≦50,
(MF1) represents a constituent obtained by polymerizing a monomer represented by CF₂═CF—Rf₁ in which Rf₁ represents a perfluoroalkyl group having 1 to 5 carbon atims,
(MF2) represents a constituent obtained by polymerizing a monomer represented by CF₂═CF—ORf₁₂ in which Rf₁₂ represents a fluorine-containing C₁₋₃₀ alkyl group,
(MF3) represents a constituent obtained by polymerizing a monomer represented by CH₂═CH—ORf₁₃ in which Rf₁₃ represents a fluorine-containing alkyl group having 1 to 30 carbon atoms,
(MA) represents a constituent having at least one crosslinking moiety, and
(MB) represents an optional constituent.

4. The antireflective film according to claim 3, wherein (MB) includes a constituent having a polysiloxane structure.

5. The antireflective film according to claim 1, wherein the composition for low refractive index layer further comprises (C) a monomer having two or more (meth)acryloyl groups in a molecule thereof.

6. The antireflective film according to claim 1, wherein the composition comprises (D) inorganic fine particles having an average particle size of from 1 to 200 nm.

7. The antireflective film according to claim 6, wherein the inorganic fine particles (D) includes a porous inorganic fine particle or an inorganic fine particle having a cavity inside thereof.

8. The antireflective film according to claim 1, wherein the composition for low refractive index layer further comprises (E) a fluorine-containing antifouling agent having a functional group capable of being cured with ionizing radiation.

9. The antireflective film according to claim 1, wherein the conductive polymer composition is distributed unevenly in a part, closer to the support in a thickness direction, of the low refractive index layer.

10. A polarizing plate comprising a polarizer and two protective films for protecting both a surface side and back side of the polarizer, wherein one of the protective films is an antireflective film comprising:
a support; and
a low refractive index layer formed from a composition for low refractive index layer, the composition including the components (A) and (B):
(A) a fluorine-containing polymer having a crosslinking group, and
(B) a conductive polymer composition including a π-conjugated conductive polymer and a polymer dopant having an anion group, the conductive polymer composition being hydrophobized,
wherein the antireflective film has a Log SR of 13 or less, Log SR being a common logarithm of a surface resistivity SR (Ω/sq) of a surface on a side having the low refractive index layer with respect to the support.

11. An image display device comprising an antireflective film or a polarizing plate,
wherein the antireflective film comprises:
a support; and
a low refractive index layer formed from a composition for low refractive index layer, the composition including the components (A) and (B):
(A) a fluorine-containing polymer having a crosslinking group, and
(B) a conductive polymer composition including a π-conjugated conductive polymer and a polymer dopant having an anion group, the conductive polymer composition being hydrophobized,
wherein the antireflective film has a Log SR of 13 or less, Log SR being a common logarithm of a surface resistivity SR (Ω/sq) of a surface in a side having the low refractive index layer with respect to the support, and
wherein the polarizing plate comprises:
a polarize and two protective films for protecting both a surface side and back side of the polarizer, wherein one of the protective films is an antireflective film comprising:
a support; and
a low refractive index layer formed from a composition for low refractive index layer, the composition including the components (A) and (B):
(A) a fluorine-containing polymer having a crosslinking group, and
(B) a conductive polymer composition including a π-conjugated conductive polymer and a polymer dopant having an anion group, the conductive polymer composition being hydrophobized,
wherein the antireflective film has a Log SR of 13 or less, Log SR being a common logarithm of a surface resistivity SR (Ω/sq) of a surface on a side having the low refractive index layer with respect to the support.
